(19) United States
(12) Patent Application Publication
(10) Pub. No.: US 2025/0324390 A1
(43) Pub. Date: Oct. 16, 2025

(54) RADIO AGNOSTIC PEER DEVICE LOCATIONING

(71) Applicant: QUALCOMM Incorporated, San Diego, CA (US)

(72) Inventors: G SRIRAM, Karaikudi (IN); Feliciano GOMEZ MARTINEZ, Los Gatos, CA (US); Akansh JAIN, Chennai (IN); Xiaoxin ZHANG, Sunnyvale, CA (US); Bala RAMASAMY, San Marcos, CA (US)

(21) Appl. No.: 18/893,776

(22) Filed: Sep. 23, 2024

Related U.S. Application Data
(60) Provisional application No. 63/634,842, filed on Apr. 16, 2024.

(51) Int. Cl. H04W 64/00

(52) U.S. Cl. CPC H04W 64/003

(57) ABSTRACT

Aspects presented herein may enable a wireless device to intelligently select one or more ranging technologies that are most suitable for locationing and tracking based the condition(s) and/or surrounding(s) of the wireless device. In one aspect, a first UE exchanges, with a second UE, capability information related to ranging technologies supported for positioning or ranging. The first UE obtains a first set of parameters related to a set of ranging technologies of the first UE, a set of measurements from the set of ranging technologies of the first UE, and a second set of parameters from at least one application. The first UE selects at least one ranging technology from the set of ranging technologies for positioning or ranging based on the exchanged capability information, the first set of parameters, the set of measurements, and the second set of parameters.

### CROSS REFERENCE TO RELATED APPLICATION(S)

This application claims the benefit of and priority to U.S. Provisional Application Ser. No. 63/634,842, entitled “RADIO AGNOSTIC PEER DEVICE LOCATIONING” and filed on Apr. 16, 2024, which is expressly incorporated by reference herein in its entirety.

### TECHNICAL FIELD

The present disclosure relates generally to communication systems, and more particularly, to wireless communication involving tracking and locationing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning and tracking/ranging protocols and techniques that enable mobile network operators to provide high-accuracy location/tracking/ranging services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus (e.g., at a first user equipment (UE)) exchanges, with a second UE, capability information related to ranging technologies supported for positioning or ranging. The apparatus obtains a first set of parameters related to a set of ranging technologies of the first UE, a set of measurements from the set of ranging technologies of the first UE, and a second set of parameters from at least one application. The apparatus selects at least one ranging technology from the set of ranging technologies for positioning or ranging based on the exchanged capability information, the first set of parameters, the set of measurements, and the second set of parameters.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of tracking in accordance with various aspects of the present disclosure.

FIG. 6 is a diagram illustrating an example user experience of a finder device locating a target device in accordance with various aspects of the present disclosure.

FIG. 7 is a diagram illustrating an example of a UE including a unified radio agnostic application programming interface (API), an optimal location engine (OLE), and a unified radio access technology (RAT) discovery (URD) module/protocol in accordance with various aspects of the present disclosure.

FIG. 8 is a diagram illustrating an example architecture of an OLE in accordance with various aspects of the present disclosure.

FIG. 9 is a diagram illustrating an example of a UE obtaining non-peer-to-peer (non-P2P) information from a cloud in accordance with various aspects of the present disclosure.

FIG. 10 is a diagram illustrating an example of ranging technology/RAT combining in accordance with various aspects of the present disclosure.

FIG. 11 is a diagram illustrating an example of location resource manager (LRM) in accordance with various aspects of the present disclosure.

FIG. 12 is a diagram illustrating an example of ranging by proxy (RBP) in accordance with various aspects of the present disclosure.

FIG. 13A is a diagram illustrating an example of two media access control (MAC) addresses corresponding to two different peer devices in accordance with various aspects of the present disclosure.

FIG. 13B is a diagram illustrating an example of two MAC addresses corresponding to the same peer device in accordance with various aspects of the present disclosure.

FIG. 14 is a diagram illustrating an example of multiple devices discovering ranging technologies/RATs of other devices based on URD in accordance with various aspects of the present disclosure.

FIG. 15 is a diagram illustrating an example scenario of two devices communicating with each other based on two different ranging technologies in accordance with various aspects of the present disclosure.

FIG. 16 is a flowchart of a method of wireless communication.

FIG. 17 is a diagram illustrating an example of a hardware implementation for an example apparatus and/or network entity.

### DETAILED DESCRIPTION

Various aspects relate generally to wireless communication and more particularly to tracking and/or ranging based on wireless communication. Some aspects more specifically relate to improving the overall performance of locationing and tracking for wireless devices that are capable of performing locationing and tracking with at least one ranging technology and/or radio access technology (RAT). Aspects presented herein may enable a wireless device to intelligently select one or more ranging technologies/RATs that are most suitable for locationing and tracking based the condition(s) and surrounding(s) of the wireless device. Aspects presented herein may also enable a wireless device to combine locationing and tracking measurements from one or more ranging technologies/RATs, such that multiple ranging technologies/RATs may be used concurrently/simultaneously to achieve a more accurate locationing and tracking compared to using just one ranging technology/RAT.

Particular aspects of the subject matter described in this disclosure can be implemented to realize one or more of the following potential advantages. Aspects presented herein may apply to any device that has (or supports) at least one ranging technology (e.g., ultra-wideband (UWB), Wi-Fi®, Bluetooth®, etc.) and/or at least one RAT (e.g., 4G LTE, 5G NR, 6G, etc.) that could be used for locationing and sensing applications. For purposes of the disclosure, the ranging technology may also be referred to as the RAT depending on the context. As such, the term “radio access technology (RAT)” may broadly encompass all types of wireless communication technologies including UWB, Wi-Fi, Bluetooth, 4G LTE, 5G NR, 6G, etc. Even for devices that have just one location-capable ranging technology/RAT, aspects presented herein may enable those devices to abstract away which ranging technology/RAT is being used (e.g., for locationing and sensing), so that mobile application may not specify to be modified to interact with each ranging technology/RAT (or with a different ranging technology/RAT). Aspects presented herein may apply to applications used for finding distance, angle of arrival (AoA) and/or any other location and sensing parameters with a peer device.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

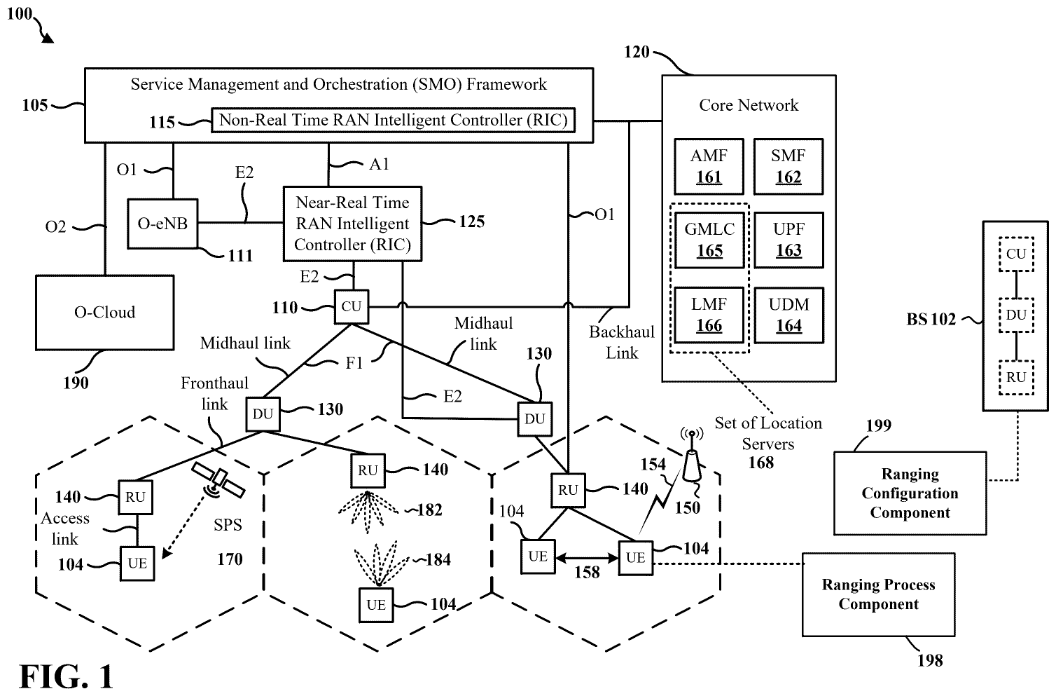

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a ranging process component 198 that may be configured to exchange, with a second UE, capability information related to ranging technologies supported for positioning or ranging; obtain a first set of parameters related to a set of ranging technologies of the first UE, a set of measurements from the set of ranging technologies of the first UE, and a second set of parameters from at least one application; and select at least one ranging technology from the set of ranging technologies for positioning or ranging based on the exchanged capability information, the first set of parameters, the set of measurements, and the second set of parameters. In certain aspects, the base station 102 may have a ranging configuration component 199 that may be configured to provide configurations and/or parameters related to ranging technology/technologies supported by the UE 104 for the UE 104.

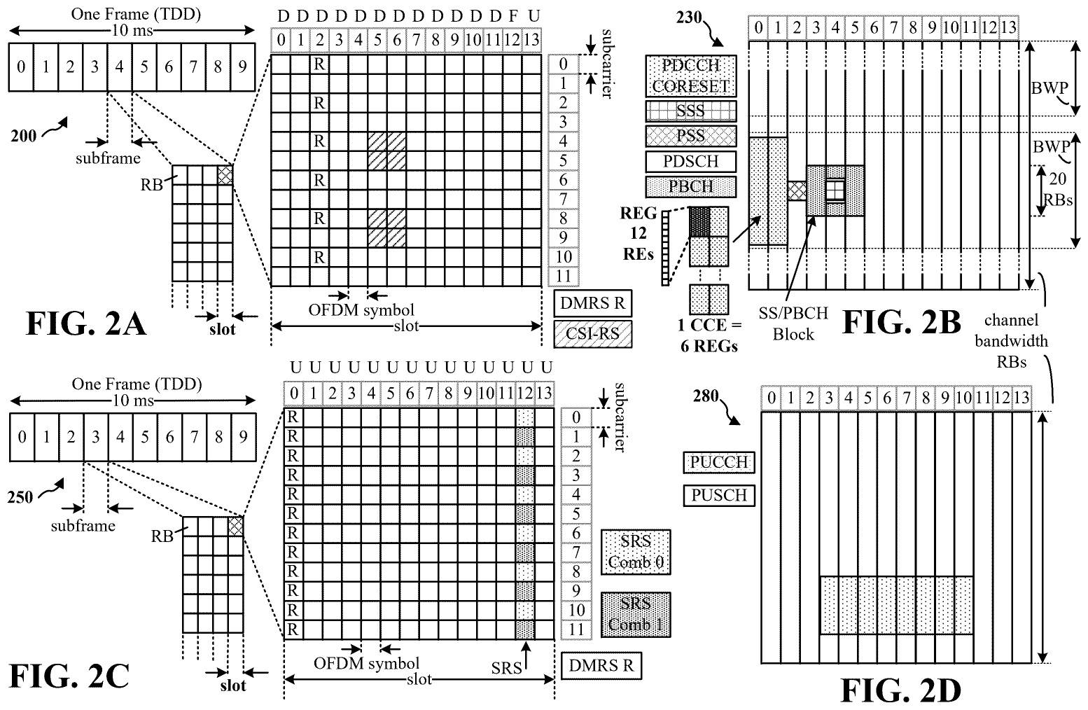

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2 slots/subframe. The subcarrier spacing may be equal to 2*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

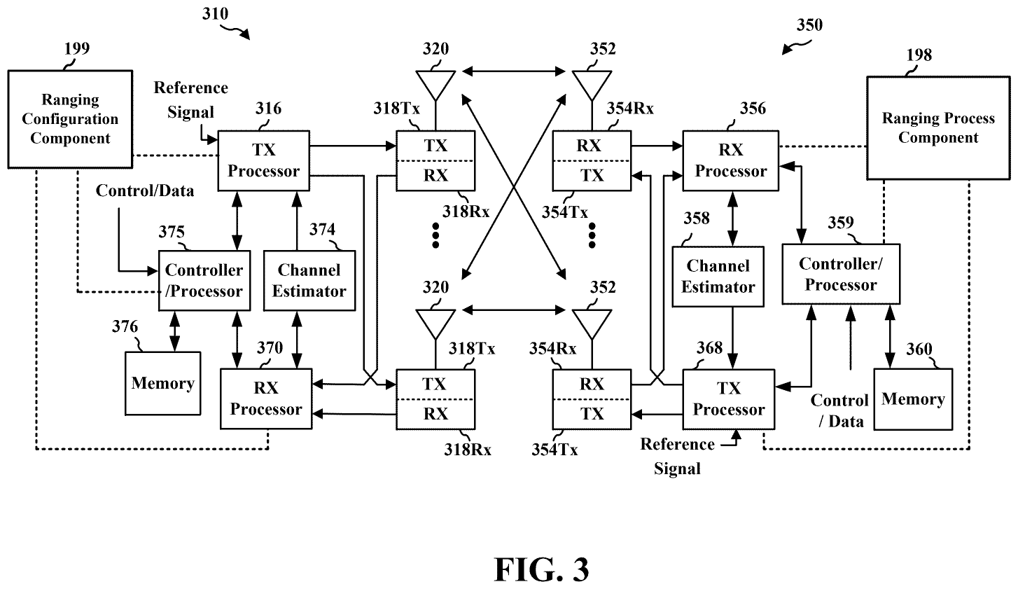

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the ranging process component 198 of FIG. 1.

At least one of the TX processor 316, the RX processor 370, and the controller/processor 375 may be configured to perform aspects in connection with the ranging configuration component 199 of FIG. 1.

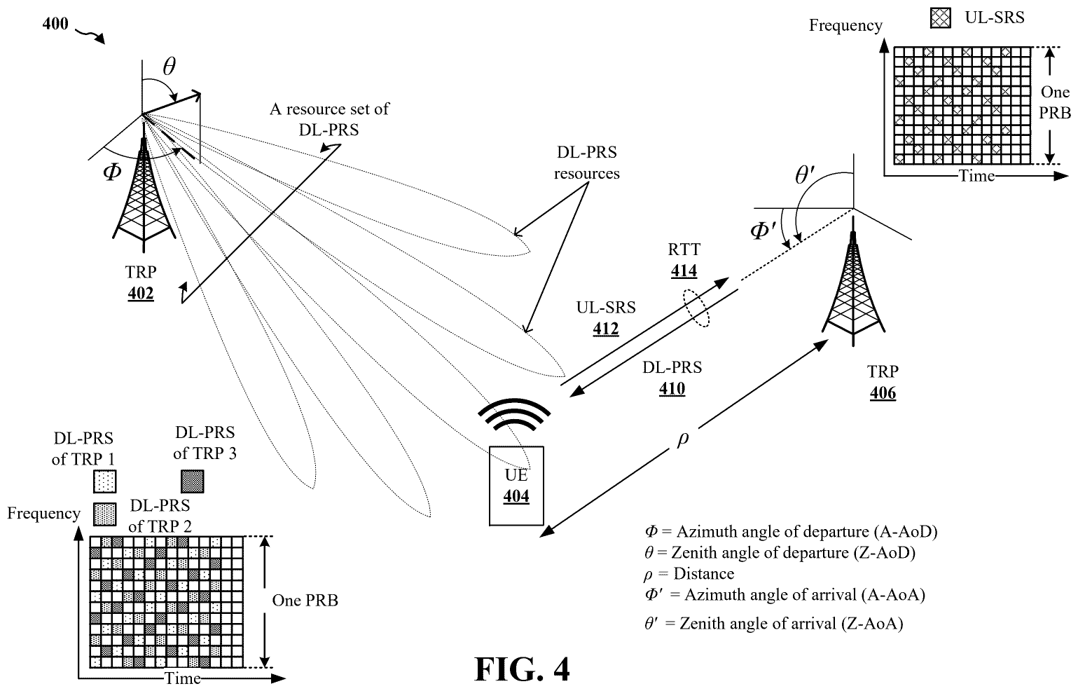

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS}_TX. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In addition to the network-based positioning described in connection with FIG. 4, various positioning methods/mechanisms have also been developed for localizing or tracking the position of a target. These positioning methods/mechanisms may be classified into active positioning (which may also be referred to and used interchangeably with “active localization”) and passive positioning (which may also be referred to and used interchangeably with “passive localization”). The active positioning may specify that a target that is to be positioned and tracked to be implemented with or attached to a tracker, such as a tag (e.g., a radio frequency (RF) tag) or a positioning device (e.g., a UE, a device capable of transmitting/receiving positioning reference signals, a device capable of performing or responding to ranging/radar operations, etc.), etc. On the other hand, for passive positioning, a target may be localized and tracked without attaching to tracker. For example, in a passive positioning system, such as a radar system, the reflection of electromagnetic wave from the surface of a target body may cause a distortion to the measured signal. Such distortions in communication channel may be the source of information for the sensing/perception task, like object/person localization.

A wireless device may be able to locate and track another wireless device based on tracking technology and/or ranging technology. For purposes of the present disclosure, tracking technology may refer to methods and systems that are used for monitoring and following the movement or location of targets (e.g., objects, people, animals, vehicles, etc.) over time. Tracking technology may have different applications across various industries, and may use different principles and devices to achieve the tracking. Ranging technology may refer to the various methods and techniques used to measure the distance between two points or objects. These technologies may be used in various fields such as surveying, navigation, robotics, telecommunications, etc. Examples of tracking technology may include:
(1) global navigation satellite system (GNSS)/global positioning system (GPS) tracking—GNSS/GPS tracking relies on a network of satellites to provide real-time location information. GNSS/GPS receivers, often embedded in devices like smartphones, vehicles, or wearables, may determine their precise location and movement.
(2) radio-frequency identification (RFID) tracking—RFID technology uses radio waves to identify and track objects equipped with RFID tags, where these RFID tags may include electronic information that can be read by RFID readers, enabling the tracking of items in logistics, inventory management, and access control.
(3) Bluetooth® (BT) tracking—Bluetooth technology, including Bluetooth channel sounding (CS) (BTCS) may be used for tracking by measuring the signal strength between devices. Bluetooth beacons or tags may be attached to objects or carried by individuals, and their proximity to Bluetooth receivers may be used to estimate their location.
(4) Wi-Fi® tracking—Wi-Fi positioning may involve using the signals from Wi-Fi access points (APs) to estimate the location of target devices. This positioning method is often suitable for indoor environments, such as malls and airports, for tracking people or assets.
(5) cellular tracking—mobile network infrastructure may be able to track devices through the triangulation of cell tower signals. The approximate location of a mobile device can be determined by analyzing the signals it receives from nearby cell towers.
(6) inertial navigation systems—these systems may use accelerometers and gyroscopes to track changes in velocity and orientation.
(7) computer vision tracking—advanced computer vision technologies, including object recognition and tracking algorithms, may enable cameras and sensors to track the movement of objects or people based on visual data.
(8) ultra-wideband (UWB) tracking—UWB tracking may utilize signals with very high frequency ranges or bandwidths. UWB technology transmits data using a broad spectrum of frequencies, enabling precise and accurate tracking of objects or individuals in both indoor and outdoor environments. UWB tracking systems typically operate in the frequency range of 3.1 to 10.6 gigahertz.

Examples of ranging technology may include:
(1) triangulation—triangulation involves measuring the angles between an observer and two known points or landmarks. By using trigonometry, the distance to the object may be calculated or estimated.
(2) time of flight (ToF)—ToF technology measures the time taken for a signal (such as light or sound) to travel from a transmitter to a target and back to a receiver. By knowing the speed of the signal, usually the speed of light or sound, the distance may be calculated or estimated.
(3) GNSS—GNSS systems, such as GPS, global navigation satellite system (GLONASS), Galileo, and BeiDou, use signals from satellites to determine the position of a receiver on Earth. By analyzing the time it takes for signals from multiple satellites to reach the receiver, its position (including distance) may be calculated or estimated.
(4) RFID—RFID technology uses electromagnetic fields to automatically identify and track tags attached to objects. The distance between the reader and the RFID tag may be estimated based on the strength of the received signal.
(5) ultrasonic ranging—ultrasonic ranging involves emitting ultrasonic pulses and measuring the time it takes for the pulses to bounce back from the object. The speed of sound in the medium determines the distance.
(6) laser ranging (e.g., light detection and ranging (Lidar))—laser ranging uses lasers to measure the distance to a target by calculating the time it takes for laser pulses to travel to the target and back.

The UWB devices (e.g., devices that are capable of performing UWB tracking/ranging) may use pulse-based radio signaling (e.g., Short-pulse-UWB) instead of OFDM-based signaling (Multi-Band OFDM UWB). Short-pulse-UWB signaling transmits with the energy for each bit spread over the entire UWB channel bandwidth (e.g., 1.37 GHz, 4 GHz, etc.) with varying pulse amplitude and/or pulse polarity without using a RF carrier while MB-OFDM (Multi-Band-OFDM) transmits each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various shapes (e.g., Gaussian pulses, Monocycle pulses, Hermite pulses, etc.) and the shape used may be chosen based on their properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high speed Analog-to-Digital converter (ADC) and a high speed Digital-to-Analog Converter (DAC) to be able to handle the very wide frequency band used; however, there may be other ways to handle the need for ultra-fast sampling such as using Time Hopping techniques, Direct Sequence coding techniques, etc.

Multiband OFDM UWB divides up spectrum into several frequency sub-bands and OFDM is applied within each band; whereas, other OFDM systems typically operate within a fixed frequency band. The complex waveform created by combining the multiple-sub-bands results in a final waveform that used for transmission for Multiband OFDM UWB. Multiband OFDM UWB also varies from other OFDM systems by not using a guard interval, using simpler modulation schemes like Binary Phase Shift keying (BPSK) or Quadrature phase-shift keying (QPSK) vs. 64 or 256 Quadrature Modulation (QAM), utilizes a constant power level whereas other OFDM systems may utilize power control for varying channel conditions, etc.

Bluetooth tracking may refer to using Bluetooth technology to locate and track objects, people, or assets within a certain range. This technology may rely on Bluetooth-enabled devices, such as smartphones, tablets, or specialized Bluetooth tags, to communicate with each other and determine their relative positions.

Bluetooth tracking may include beacon-based tracking and Bluetooth low energy (LE) tracking. Beacon-based tracking may involve deploying Bluetooth beacons that emit Bluetooth signals at regular intervals. These signals are picked up by Bluetooth-enabled devices in the vicinity, such as smartphones or tablets. By measuring the signal strength and timing of these beacon signals, the receiving devices can estimate their proximity to the beacon. This information may then be used to determine the location of the Bluetooth-enabled device within the range of the beacon. Bluetooth LE tracking may enable devices to communicate over short distances while consuming minimal power. Bluetooth LE tracking systems may include attaching tags to objects or carried by individuals, and Bluetooth LE receivers (such as smartphones or dedicated receivers) that scan for these tags. The receivers detect the signals transmitted by the tags and use signal strength and other parameters to estimate the distance between the tag and the receiver. By triangulating signals from multiple receivers, the system can determine the location of the tagged object or person.

Bluetooth channel sounding (CS) is a technique used in Bluetooth communication to assess the quality and characteristics of the radio channel between devices. When devices communicate over Bluetooth, they may encounter various obstacles such as walls, interference from other devices, or signal attenuation due to distance. Bluetooth channel sounding involves sending specific signals between devices and analyzing the responses to gain insights into the channel's characteristics. This process helps devices adjust their transmission parameters, such as power levels and modulation schemes, to optimize communication reliability and data throughput. By performing channel sounding, devices may adapt to changing environmental conditions, improving the overall performance and robustness of Bluetooth connections.

Wi-Fi tracking may be used for monitoring and tracking the movement of devices within a Wi-Fi network's coverage area. Wi-Fi tracking may rely on the unique media access control (MAC) addresses of Wi-Fi-enabled devices, such as smartphones, tablets, and laptops, to identify and track them as they move within the network's range. For example, Wi-Fi tracking utilizes Wi-Fi access points (APs), which are devices that provide wireless network connectivity to devices within their range. These access points continuously broadcast Wi-Fi signals, allowing Wi-Fi-enabled devices to connect to the network. When Wi-Fi-enabled devices come within range of Wi-Fi access points, they may be configured to automatically send out probe requests, seeking available networks to connect to. Wi-Fi access points receive these probe requests and respond with probe responses containing information about the network, such as the service set identifier (SSID) and signal strength. Each Wi-Fi-enabled device may have a unique MAC address associated with its network interface. Wi-Fi tracking systems capture these MAC addresses from the probe requests and responses exchanged between devices and access points. Location Calculation: By monitoring the signal strength and timestamps of probe requests and responses from multiple access points, Wi-Fi tracking systems may triangulate the position of Wi-Fi-enabled devices within the network's coverage area.

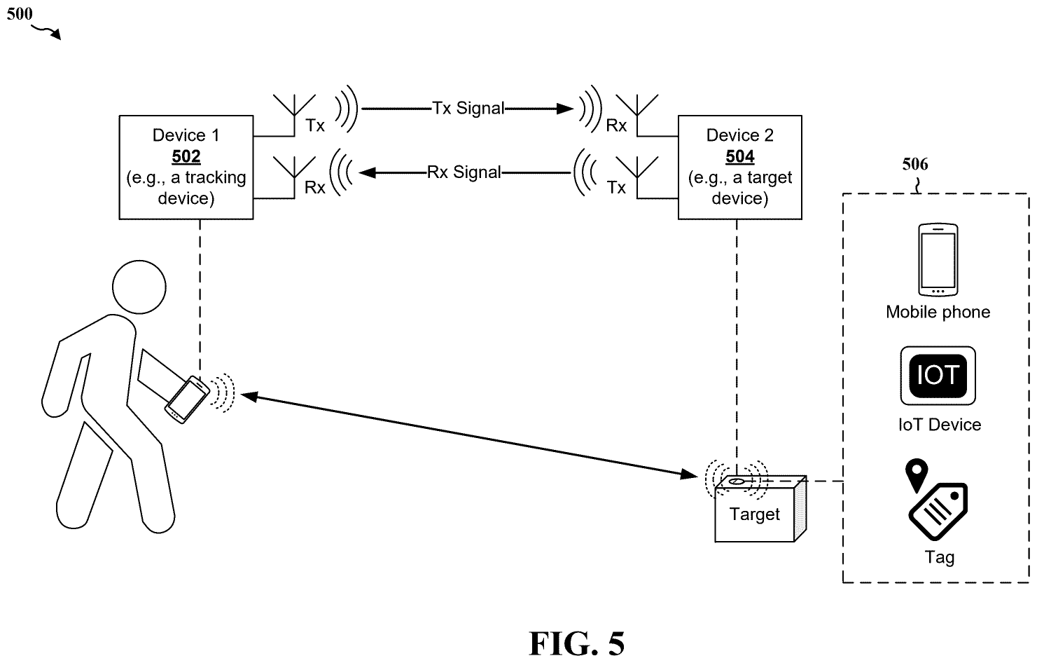

FIG. 5 is a diagram 500 illustrating an example of tracking (e.g., active positioning) in accordance with various aspects of the present disclosure. A first device 502 (which may also be referred to as a “tracking device” or a “finder device” for purposes of the present disclosure) may be able to locate a second device 504 (which may also be referred to as a “target” or a “target device” for purposes of the present disclosure) based on transmitting signals (which may be referred to as “transmission (Tx) signals”) to the second device 504, and receive signals (which may be referred to as “reception (Rx) signals”) from the second device 504. Depending on implementations, the Rx signals may be signals reflected from the second device 504 (e.g., based on the Tx signals) or signals generated by the second device 504. Then, based on the time-of-flight (ToF) of the Tx signals and the Rx signals, the first device 502 may estimate the distance of the second device 504 from the first device 502. In some configurations, if the first device is also capable of measuring the angle-of-arrival (AoA) of the Rx signals, the first device 502 may also be able to estimate the direction of the second device 504 from the first device 502 (which may be referred to as the relative direction from the first device 502). As shown at 506, the second device 504 may be a mobile phone, an Internet of Things (IoT) device, or a tag (e.g., an RFID tag), and the localizing and/or tracking of the second device 504 may be based on using Bluetooth® tracking, Wi-Fi tracking, or UWB tracking, etc.

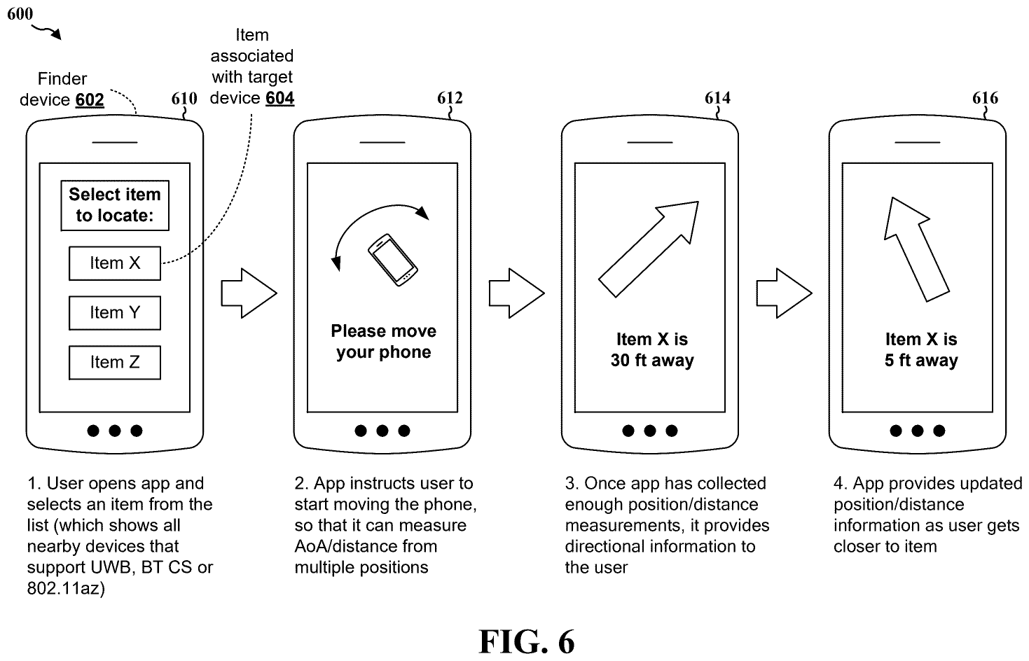

FIG. 6 is a diagram 600 illustrating an example user experience of a finder device locating a target device in accordance with various aspects of the present disclosure. As shown at 610, a finder device 602 (e.g., a mobile phone) or an application running on the finder device 602 may instruct the user to select an item (e.g., from a list of detected items) for tracking/locating. As shown at 612, after the user selects an item (e.g., item X) that is associated with a target device 604 (e.g., an RFID tag, a pair of Bluetooth earbuds, etc.), the finder device 602 may instruct the user to move the finder device 602, such that the finder device 602 may be able to measure the distance and/or AoA between the finder device 602 and the target device 604 from multiple positions. As shown at 614, after the finder device 602 has collected sufficient AoA/distance measurements, the finder device 602 may start providing directional information of the target device 604 to the user, such as by showing the direction and the distance of the target device 604 with respect to the finder device 602. Then, as shown at 616, the finder device 602 may continue to update the directional information of the target device 604 as the user moves, and may stop the update after the user locates the target device 604 (e.g., after the finder device 602 is within a threshold distance of the target device 604).

For purposes of the present disclosure, the term “position/positioning” may be used interchangeably with the term “location/locationing,” which may refer to a process of determining spatial coordinates or geographic location of an object, person, or device in relation to its surroundings. The term “sense/sensing,” in the context of positioning and tracking, may refer to a process of detecting and gathering data about the environment or a target being tracked. This may involve the use of sensors or sensing technologies that can capture relevant information such as location, movement, temperature, sound, light, or other physical parameters depending on the specifications of the tracking system.

Aspects presented herein may apply to any device that has (or supports) more than one ranging technology (e.g., UWB, Wi-Fi, Bluetooth as described in connection with FIG. 5) and/or at least one radio access technology (RAT) (e.g., 4G LTE, 5G NR, 6G, etc.) that could be used for locationing and sensing applications, such as described in connection with FIGS. 4 to 6. Even for devices that have just one location-capable ranging technology, aspects presented herein may enable those devices to abstract away which ranging technology is being used (e.g., for locationing and sensing), so that mobile application may not specify to be modified to interact with each ranging technology (or with a different RAT). Aspects presented herein may apply to applications used for finding distance, angle of arrival (AoA) and/or any other location and sensing parameters with a peer device. For simplicity of illustration, a device that supports at least one ranging technology that could be used for positioning/locationing may be referred to as a “user equipment (UE),” a “wireless device,” or just a “device,” which may include a smartphone, a tablet, an industrial machinery, a tracking/finder device, or an IoT device, etc. Also, for purposes of the disclosure, the ranging technology may also be referred to as the RAT depending on the context. As such, the term “radio access technology (RAT)” may broadly encompass all types of wireless communication technologies including UWB, Wi-Fi, Bluetooth, 4G LTE, 5G NR, 6G, etc.

Many types of wireless devices, such as smartphones, tablets, VR headsets, etc., may support multiple ranging technologies for locationing (e.g., including tracking, ranging, sensing, etc.). For example, a smartphone may have the capability to track/sense an object using Wi-Fi, Bluetooth, and UWB, etc. Each ranging technology may have its own advantage(s) and/or limitation(s). For example, in terms of ranging/locationing accuracy, UWB (e.g., operating at 500 MHz) may perform better than Wi-Fi (e.g., operating at 160 or 320 MHz) and Wi-Fi may perform better than Bluetooth (e.g., operating at 80 MHz) (e.g., UWB>Wi-Fi>Bluetooth). In terms of power consumption, Wi-Fi may perform better than UWB and UWB may perform better than Bluetooth (e.g., Wi-Fi>UWB>Bluetooth). On the other hand, in terms of range coverage, Wi-Fi may perform better than Bluetooth, and Bluetooth may perform better than UWB (e.g., Wi-Fi>Bluetooth>UWB).

In some scenarios, one ranging technology may give/generate an unreliable location estimate due to interference, range, and/or other disturbances in the received signal, while another ranging technology may provide a better estimate of the location. For example, even though UWB (operating at 500 MHz) may have better ranging accuracy compared to the Bluetooth (operating at 80 MHz), if there are significant interferences/noises around the 500 MHz, the Bluetooth may provide a more accurate ranging estimate of a target compared to the UWB under such scenario.

A wireless device supporting at least one ranging technology that can be used for locationing/ranging may typically encounter at least one of the following problems. For purposes of the present disclosure, a software or an application that accepts positioning related measurements, such as from global navigation satellite system (GNSS)/global positioning system (GPS) chipsets and/or sensors (e.g., UWB, Wi-Fi, Bluetooth, Camera, Lidar, etc.) to estimate position, velocity, and/or altitude of a device (e.g., can be the device that runs the software/application or another device) may be referred to as a positioning engine (PE) or a location engine. In addition, a positioning engine that is capable of achieving certain high level of accuracy (e.g., centimeter/decimeter level accuracy) and/or latency may be referred to as a precise positioning engine (PPE).

First, due to secure link limitation and/or power consumption, usually or most of the time, a wireless device may be configured to use just one ranging technology at a time for locationing. For a wireless device with multiple ranging technologies, the location engine of the wireless device may be specified to decide/select which ranging technology to be used to optimize the locationing performance at different conditions such as distance, power consumption, and accuracy specifications. Intelligence may be specified by the wireless device to pick the suitable/right ranging technology for the ranging/locationing. Second, there may be conditions where multiple ranging technologies may be used concurrently (usually for a short period of time), in which case a location engine may be specified to determine how to properly combine the measurements from one or more ranging technologies to optimize the locationing performance. Also, the location engine may be specified to determine which ranging technology/technologies (and/or RAT(s)) may continue to be used moving forward for the locationing and turn off (e.g., deactivates) the rest of the ranging technology/technologies (and/or RAT(s)). Third, some mobile applications/software may not know which ranging technology is adequate for a specific scenario, and may not have the correct logic to select between different ranging technologies and/or RATs on different wireless devices and/or at different times.

Aspects presented herein may improve the overall performance of locationing and tracking for wireless devices that are capable of performing locationing and tracking with at least one ranging technology. Aspects presented herein may enable a wireless device to intelligently select one or more ranging technologies that are most suitable for locationing and tracking based the condition(s) and surrounding(s) of the wireless device. Aspects presented herein may also enable a wireless device to combine locationing and tracking measurements from one or more ranging technologies, such that multiple ranging technologies may be used concurrently/simultaneously to achieve a more accurate locationing and tracking compared to using just one ranging technology. For example, in one aspect of the present disclosure, a wireless device (e.g., a UE) may be configured to include at least the following modules: (1) a unified radio agnostic application programming interface (API), (2) an optimal location engine (OLE), and (3) a unified RAT discovery (URD) module/protocol. In some implementations, the wireless device may further include at least one of a location resource manager (LRM) module and/or a ranging by proxy (RBP) module to improve/solve resource constraint-related issues for multiple applications and devices.

In one aspect, the unified radio agnostic API may be configured to exploit abstract metrics obtained from multiple ranging technologies to report measurements and confidence level. The OLE may be configured to use the unified radio agnostic API to collect measurements from one or more ranging technologies/RATs and to intelligently select the optimal ranging technology/technologies and/or RATs for locationing based on current conditions and to optimally combine measurements from one or more ranging technologies/RATs to improve locationing performance. In some scenarios, the OLE may also leverage a cloud entity or any other centralized device (e.g., a server, a crowdsourcing database, etc.) and exploits both peer-to-peer (P2P) and non-P2P information to assist the locationing. The URD module/protocol may enable the wireless device to detect availability of multiple ranging technologies/RATs on peer devices, and enable application(s)/software to use any ranging technology/RAT available without specifying details and/or modifications, and may also enable wireless devices to exchange with each other information useful to optimize locationing. The LRM module and/or the RBP module may be implemented to solve the resource constraint issues for ranging with multiple devices and ranging requests from multiple applications. It may also be configured to offload the processing load to a centralized device.

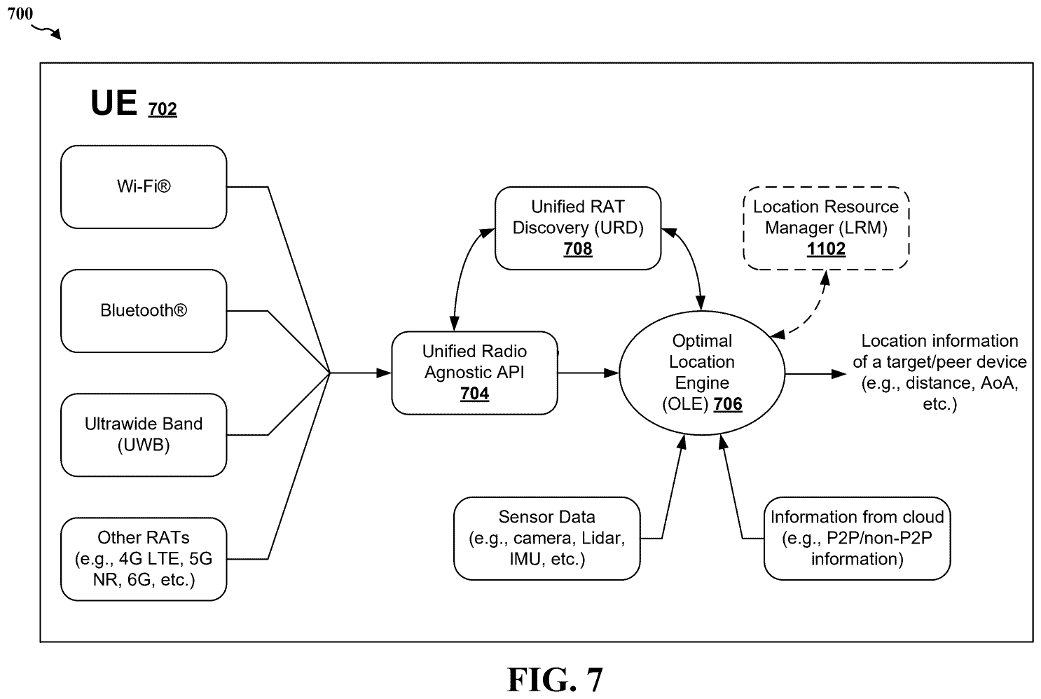

FIG. 7 is a diagram 700 illustrating an example of a UE including a unified radio agnostic API, an OLE, and an URD module/protocol in accordance with various aspects of the present disclosure. A UE 702 (e.g., the first device 502, the finder device 602, a smartphone, etc.) may include a unified radio agnostic API 704 that is configured to enable one or more ranging technologies/RATs to report their location measurements. The UE 702 may also include an OLE 706 that is capable of combining available information, multiple (locationing-related) measurements (e.g., from the unified radio agnostic API 704), sensor data, and/or obtained P2P/non-P2P information to optimize the location performance of the UE 702. The UE 702 may also include a URD module/protocol 708 that enables the UE 702 to detect availability of one or more ranging technologies/RATs on peer devices (e.g., the second device 504, another UE, etc.), enables applications/software to use any ranging technology/RAT available without specifying details, and enables the UE 702 to exchange useful locationing-related information, measurements, and/or capabilities with other wireless devices/UEs to optimize the locationing.

In one example configuration, the unified radio agnostic API 704 may be positioned between a connectivity chip and the OLE 706. Ideally, it may be more suitable to place the unified radio agnostic API 704 below an application (or an application layer) so it is capable of leveraging proprietary design(s) of a vendor/manufacturer. However, in some implementations, the unified radio agnostic API 704 may also be configured to function as an API between the connectivity chip and the application, placing the intelligence within the application. The OLE 706 may be positioned below the application to implement proprietary algorithms of a vendor/manufacturer. Alternatively, OLE 706 may be integrated within the application, which may place the intelligence there. The URD module/protocol 708 may also be positioned below the application and on top of all supported RAT technologies, thereby enabling implementation of the vendor/manufacturer's proprietary algorithms. The location resource manager (LRM) 1102 (discussed below) may be positioned at an operating system (OS) level to manage multiple applications requesting ranging measurements.

In one aspect of the present disclosure, the unified radio agnostic API 704 may include the capability to cover multiple/different unique signatures as well as common metrics from multiple/different ranging technologies/RATs supported by the UE 702. These metrics may include any parameters or information that may be used by the UE 702 (or at least one of the ranging technologies/RATs) for optimizing the locationing. For example, the metrics may include, and are not limited to, one or more parameters or information in Table 2 below.

TABLE 2
Example Metrics From One or More Ranging technologies/RATs

| Metrics | Example Parameters/Values |
|---|---|
| Channel center | 2.4 GHz/5 GHz/6 GHz for Wi-Fi |
| frequency | 7 GHz/9 GHz for UWB |
| | 2.4 GHz for Bluetooth Channel Sounding |
| | (BCS) |
| | 24 GHz to 40 GHz for mmWave |
| | 60 GHz for Wi-Fi 60 GHz |
| Channel conditions | Line-of-sight (LoS)/non-line-of-sight (NLoS) |
| | Multipath rich or light scattering |
| | Fast or slow fading |
| Packet bandwidth | 20/40/80/160/320 MHz (Wi-Fi) |
| | 40/80 MHz (BCS) |
| | 500 MHz (UWB) |
| | 1760 MHz (Wi-Fi 60 GHz) |
| Estimated location | Received signal strength indicator (RSSI) |
| parameters | Range |
| | Angle of Arrival (AoA) |
| | Angle of Departure (AoD) |
| Error estimate | Standard deviation |
| | Peak-to-peak variation |
| | Yield |
| Ranging technology/ | Ranging technology/RAT busy (for data |
| RAT availability | throughput) or ranging technology/RAT idle |
| | percentage |

Based on these metrics/parameters, the unified radio agnostic API 704 may also be configured to find out how long a set of current location parameters are valid and determine how frequently ranging may be performed. For example, based on sensor data or measurement(s) from an inertial measurement unit (IMU), if the UE 702 is detected to be static (e.g., not moving or the detected moving speed is below a speed threshold), the unified radio agnostic API 704 may enable/configure the ranging to be performed less frequently, whereas if the UE 702 is detected to be in mobile (e.g., is moving or the detected moving speed is above a speed threshold), the unified radio agnostic API 704 may enable/configure the ranging to be performed more frequently, where the frequency of performing the ranging may be dynamic and based on the velocity of the UE 702 and/or other parameters obtained from the UE.

The OLE 706 may be configured to receive and use metrics/parameters provided by the unified radio agnostic API 704, and optionally/additionally parameters from the application/software and/or parameters from the UE 702 and its sensor(s), and/or non-P2P information from a cloud server or a centralized device, and the OLE 706 may be configured to determine a set of confidence metrics for each ranging technology/RAT (of the UE 702).

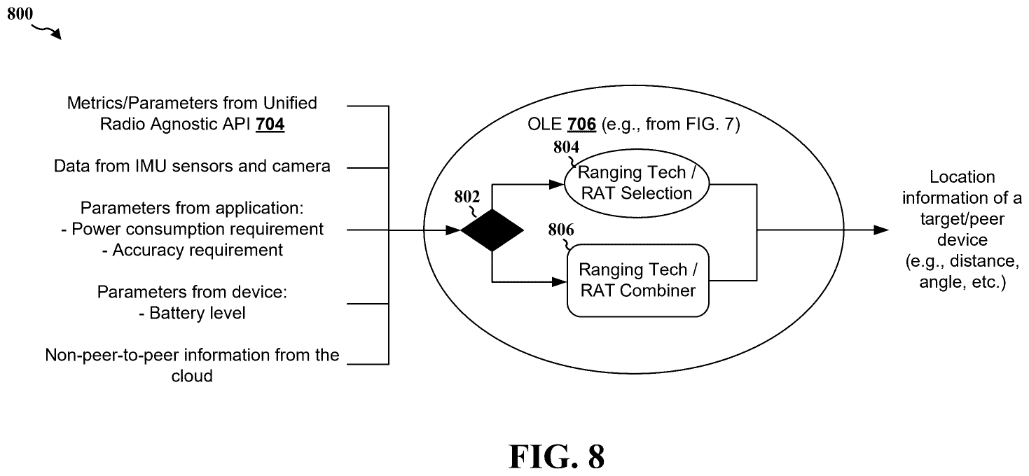

FIG. 8 is a diagram 800 illustrating an example architecture of an OLE in accordance with various aspects of the present disclosure. In some implementations, the OLE 706 may be configured to perform at least the following functions based on parameters/information provided by the unified radio agnostic API 704 and other entities/modules of the UE 702: (1) ranging technology/RAT selection, (2) ranging technology/RAT combiner (which may also be referred to as the “optimal combiner”), and (3) fusion of multiple measurements from one or more positions and/or orientations (e.g., into one measurement or a reduced number of measurements).

For example, as shown at 802, the OLE 706 may receive various parameters/information from multiple entities/modules of the UE 702, where these parameters/information may include: (1) metrics/parameters from unified radio agnostic API 704, (2) data from IMU sensors and camera, etc., (3) parameters from an application/software (e.g., power consumption specification, accuracy specification, etc.), (4) parameters from the UE 702 (e.g., battery level or a set of status of the UE), and/or (5) non-P2P/additional information from a cloud server, etc.

As shown at 804, based on at least some of the received parameters/information (e.g., from multiple entities/modules of the UE 702), the OLE 706 may be configured to select at least one ranging technology/RAT (from multiple ranging technologies/RATs) for performing the locationing and ranging. For example, from the power consumption and/or processing perspective, it may be more suitable for the UE 702 to use a single ranging technology/RAT at a time for locationing and ranging. As such, ranging technology/RAT selection may enable the UE 702 (or the OLE 706) to choose a most suitable ranging technology/RAT (which may be referred to as an “optimal ranging technology/RAT” hereafter) based on the current condition of the UE 702. Below are some examples illustrating how the UE 702 (or the OLE 706) may pick the optimal ranging technology/RAT based on various conditions.

In one example, the UE 702 (or the OLE 706) may be specified to pick a ranging technology/RAT that provides most accurate distance measurement (e.g., the distance between the UE 702 and a peer device/target device). In some scenarios, when the UE 702 sets up a link with a peer/target device (e.g., another UE), the UE 702 may obtain a rough/coarse estimate of the distance to the peer/target device, such as based on the RSSI of any of the ranging technologies/RATs. If the rough/coarse distance is estimated to be longer (e.g., exceeding a distance threshold) or the RSSI level is low (e.g., below an RSSI level threshold), the OLE 706 may be configured not to wake up (e.g., activate) UWB or BCS modules for locationing and tracking, and instead may enable the UE 702 to use the Wi-Fi for estimating the location of the peer/target device.

When the UE 702 moves towards the peer/target device, the OLE 706 may be able to sense this from the decreased distance, the increased RSSI, and/or other metrics from the enabled ranging technology (e.g., the Wi-Fi) and/or RAT. Then, the UE 702 may determine to wake up (e.g., activate) the UWB but keeps Wi-Fi connected until the UE 702 sees a strong signal (e.g., a signal strength exceeding a threshold) from the UWB. After the OLE 706 senses stable measurements from the UWB (e.g., for estimating the distance between the UE 702 and the peer/target device), the UE may disable (e.g., deactivate) the Wi-Fi.

Similarly, when the UE 702 starts moving away from the peer/target device, the OLE 706 may be configured to wake up Wi-Fi along with UWB when UWB measurements start to become instable. If the UE 702 moves farther away from the peer/target device, the OLE 706 may turn off/deactivate the UWB and use the Wi-Fi alone (e.g., as UWB may have shorter range coverage compared to the Wi-Fi).

In another example, the UE 702 (or the OLE 706) may be specified to pick a ranging technology/RAT that provides most accurate orientation of a peer/target device (e.g., with respect to the UE 702). For example, some ranging technologies/RATs may use directional antennas, with gain nulls in certain directions. When the user moves the UE 702, the UE 702 may be able to use its IMU information/measurement to predict whether the position of the peer device/target device is likely to be in the direction of antenna null for one ranging technology/RAT, and then the UE 702 may be configured to proactively change to another antenna (or another ranging technology/RAT) to avoid losing track of the peer/target device. For purposes of the present disclosure, depending on the context, an orientation may refer to the orientation of UE(s) and/or ranging technology/technologies/RAT(s) in some examples, or it may refer to the orientation of one or more antennas of a UE for a ranging technology/RAT in some examples.

In another example, the UE 702 (or the OLE 706) may be specified to pick a ranging technology/RAT that provides best power consumption. For example, if the battery level of the UE 702 is high (e.g., above a power level threshold) or in plugged in mode (e.g., with a power bank connected or is connected to an outlet), the OLE 706 may enable Wi-Fi for a longer period of time even when the UWB is also enabled. Also, if the battery level is high, the OLE 706 may also enable multiple ranging technologies/RATs to be used (for locationing/tracking) simultaneously, so that the OLE 706 may use ranging (measurements) from one ranging technology/RAT to calibrate another ranging technology/RAT.

Conversely, if the battery level is low, the OLE 706 may enable/activate the ranging technology/RAT which has the lowest power consumption, e.g., Bluetooth alone. In some examples, the OLE 706 may be configured to use/leverage Bluetooth low energy (BLE) periodic advertisements as a low-power low-cost solution to determine when to run UWB/Wi-Fi again. For example, in a navigation involving a long range walk, there may not be a specification to use UWB/Wi-Fi the entire time. The UE 702/OLE 706 may run the BLE periodic advertisements in the background all the time, and just enable the UWB at points/occasions that specify high accuracy like turning points, and/or just enable Wi-Fi at a long distance, etc.

In another example, the UE 702 (or the OLE 706) may be specified to pick a ranging technology/RAT that meets an accuracy specification. The conditions may be determined by type of applications such as unlocking car/house, finding an earbud, locating a person, each of which may specify different level of accuracy. For applications that specify high level of location accuracy, UWB may be used instead of Wi-Fi or Bluetooth.

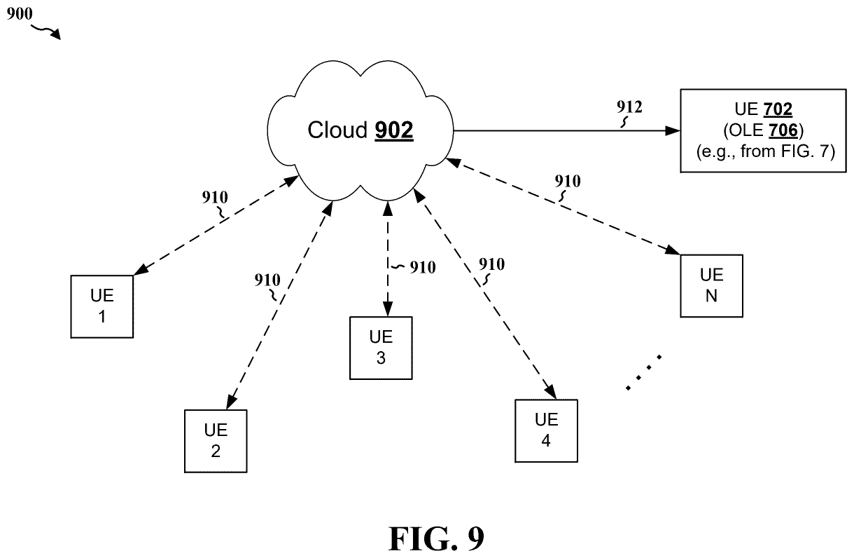

FIG. 9 is a diagram 900 illustrating an example of a UE (e.g., the UE 702) obtaining non-peer-to-peer (non-P2P) information from a cloud in accordance with various aspects of the present disclosure. In some implementations, the OLE 706 may have the capability to obtain and utilize non-P2P information from a cloud server. For purposes of the present disclosure, peer-to-peer or P2P information may refer to information that are exchanged directly between UEs, such as between the UE 702 and a peer/target UE. On the other hand, non-peer-to-peer or non-P2P information may refer to information that are not exchanged directly between UEs and/or information that is exchanged/obtained in a non-peer-to-peer way, such as information obtained from a third entity such as a server (e.g., a cloud server, a location server, etc.). The non-P2P information may also be referred to as additional information (obtained from the server) in some examples.

In some examples, some metrics/parameters discussed in connection with FIGS. 7 and 8 that are capable of assisting the OLE 706 (e.g., to select a suitable ranging technology/RAT) may also be obtained in a non-P2P way through a cloud entity or any other centralized device. For example, as shown at 910, other than UEs directly sharing information with each other in a P2P fashion (e.g., directly with each other), a set of UEs (e.g., UE 1 to UE N) may also share relevant parameters and measurements (such as GNSS measurements, latitude/longitude points, ranging technology/RAT capabilities, operating frequency channels, supported features, sensor and camera measurements, etc.) with a cloud 902.

As shown at 912, when the UE 702 is requested to locate a peer/target device/UE, the information in the cloud 902 may be processed by the cloud 902 to determine the optimal ranging technology/technologies/RAT(s) that may be used by the UE 702, e.g., by estimating coarse distance between the UEs, identifying LoS/NLoS channel condition between the UEs, selecting common ranging technologies/RATs and channels supported by both UEs, considering the power level of both UEs, etc. For example, there may be a set of visual identifiers that may help with determining proximity between two UEs. In this example, both UEs may use camera to sense the surroundings and send images to the cloud 902. The cloud 902 may combine image information with map information to help identify the coarse locations of the UEs and determine if the UEs are close to each other or far away from each other, and if there is LoS/NLoS between them, and hereby recommend which ranging technology/RAT to use for the UEs.

Referring back to FIG. 8, as shown at 806, the OLE 706 may also be configured to perform ranging technology/RAT combining (e.g., via a ranging technology/RAT optimal combiner module). In some instances, the UE 702 (or the OLE 706) may enable/permit multiple ranging technologies/RATs to be used concurrently because of: (1) no power consumption concern (e.g., the UE 702 has high battery level or is in a plugged-in mode), (2) application(s) demanding very high level of location accuracy (e.g., unlocking highly valuable assets such as bank locks, cars, house, etc.), and/or (3) transition times of switch from one ranging technology/RAT to another ranging technology/RAT (e.g., from Wi-Fi to Bluetooth or UWB, the OLE 706 may be configured to activate/wake up Bluetooth/UWB and Wi-Fi is still enabled/activated for a short period of time and/or any other scenarios where multiple ranging technologies/RATs are enabled.

In such scenarios where there may be measurements from multiple ranging technologies/RATs, the OLE 706 may be configured to derive a confidence level as a function of all the parameters/information obtained from the unified radio agnostic API 704, such as the packet bandwidth, RSSI, channel conditions, etc. For example, wider bandwidth may have a higher confidence level than a narrower bandwidth, higher RSSI may have a higher confidence level than a lower RSSI, a LoS channel may have a higher confidence level than an NLoS channel, and/or a multipath light channel may have a higher confidence level than a multipath rich channel, etc. Then, based on the derived confidence level, the OLE 706 may optimally combines the measurements from multiple/all ranging technologies/RATs.

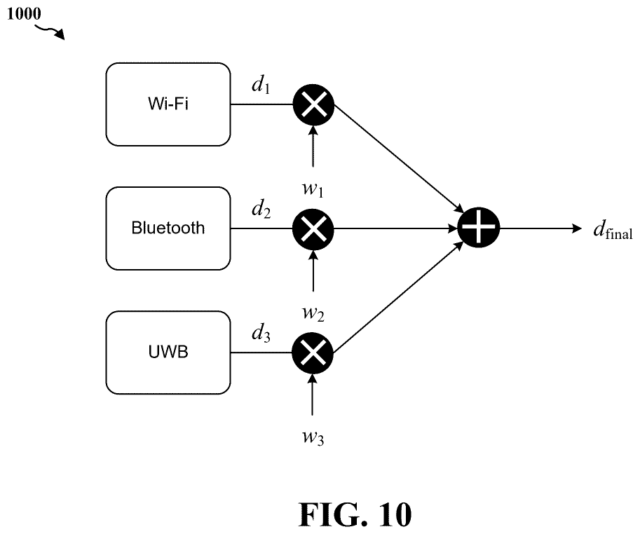

FIG. 10 is a diagram 1000 illustrating an example of ranging technology/RAT combining in accordance with various aspects of the present disclosure. As an illustration, assuming a final computed distance (d_{final}) between the UE 702 and a peer/target device/UE is the weighted sum of distances estimated from three ranging technologies/RATs: Wi-Fi, Bluetooth, and UWB. Let d₁, d₂, d₃ be the distances estimated by Wi-Fi, Bluetooth, and UWB, respectively, and w₁, w₂, w₃ be the weights assign/given to them, respectively, to compute the final distance (d_{final}) such that:

$${w}_{1} + {w}_{2} + {w}_{3} = 1 and 0 \leq {w}_{1} , {w}_{2} , {w}_{3} \leq 1.$$

The weights (which may be an example of the confidence metrics) may be computed as a function of all the parameters given by the unified radio agnostic API 704. Note this is just one example way to perform the ranging technology/RAT combining. Aspects presented herein are not limited to this method and may apply to any way of combining location parameters from multiple ranging technologies/RATs. In addition, while Wi-Fi, Bluetooth, and UWB are used as example ranging technologies/RATs for locationing and tracking, other types of ranging technologies/RATs discussed in connection with FIGS. 4 and 5 may also be used for the locationing and tracking described herein.

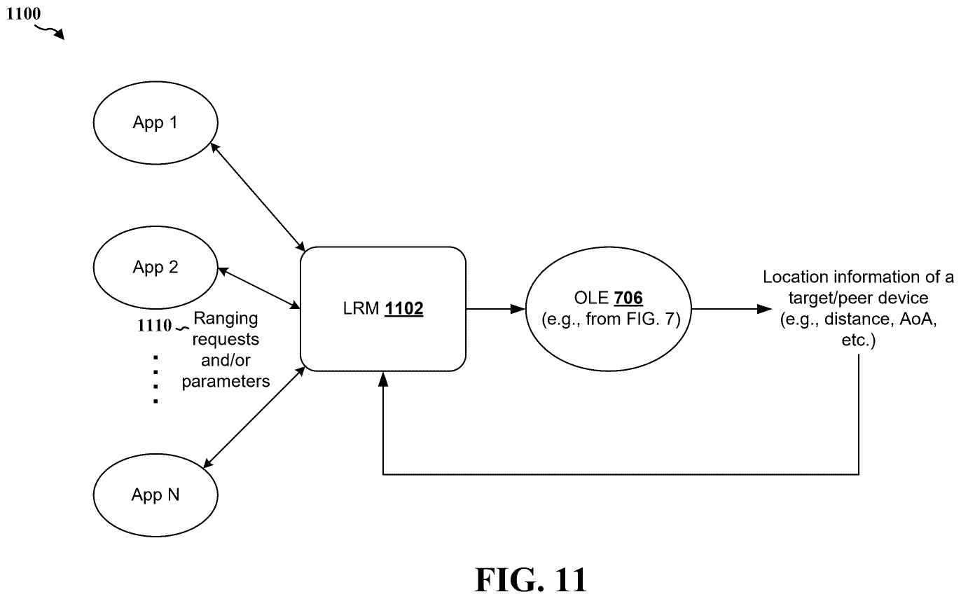

FIG. 11 is a diagram 1100 illustrating an example of location resource manager (LRM) in accordance with various aspects of the present disclosure. In some scenarios, if multiple applications (apps) of the UE 702 are requesting ranging measurements, or if a single application (app) is requesting ranging measurements to be done with multiple peer/target UEs at the same time, the UE 702 may run into resource constraint issues without proper optimization done at the operating system (OS) level. As such, in another aspect of the present disclosure, the UE 702 may further be implemented with a generic location resource manager (LRM) 1102 (also shown by the diagram 700 of FIG. 7), which may be configured to interacts with the unified radio agnostic API 704 and/or the OLE 706, and to arbitrate/prioritize between different ranging requests from different (e.g., multiple) applications or with different peer/target UEs. For example, as shown at 1110, the LRM 1102 may be configured to take various parameters (which may be given by the unified radio agnostic API 704) into account and determine a suitable/optimal resource allocation of the ranging/locationing. The LRM 1102 may serve the specifications of every application that requests ranging and influences the OLE 706 on the ranging technology/RAT selection, and the LRM 1102 may also be configured to determine what measurements/data are specified to be given to a particular application.

In some scenarios, there may be situations where one or more ranging sessions are not available for an application. For example, when a ranging technology/RAT is busy with data traffic or interacts with other application(s), or when multiple applications are requesting measurements at the same time. This may lead to latency in obtaining the location information at the UE 702. At those instances, the LRM 1102 may assess the specifications of each application, and then allocate resources accordingly. For example, the LRM 1102 may map the application to a ranging technology or use the previous location information based on its accuracy specifications. If an application specifies highly accurate measurements, the LRM 1102 may also influence mapping its request to enable UWB to obtain more accurate location. On the other hand, if an application just specifies coarse measurements, the LRM 1102 may just use the previous location information if the measurements were taken within a defined period of time (e.g., within T seconds, milliseconds, etc.), in case the ranging technologies/RATs are busy.

In some examples, the LRM 1102 may also enable dynamic switching to switch to sensors and camera based on the parameters, applications, and/or specifications, or if the ranging technologies/RATs are busy. As an example, the LRM 1102 may enable switching over to visual and IMU sensing/ranging if the UE 702 (or its OS) is configured to survey the environment or if the UE 702 just specifies to detect the proximity of a peer/target UE.

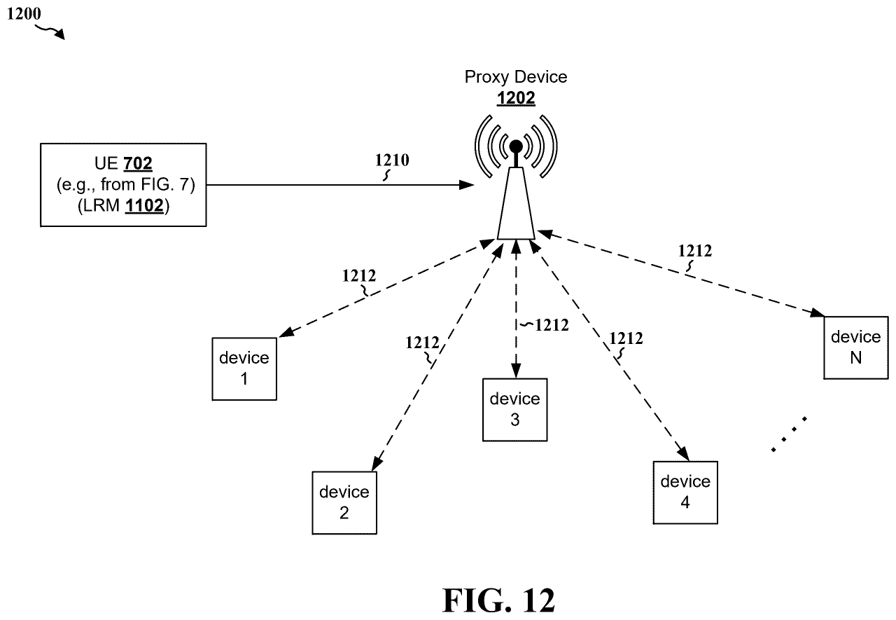

FIG. 12 is a diagram 1200 illustrating an example of ranging by proxy (RBP) in accordance with various aspects of the present disclosure. In some scenarios, when the UE 702, such as a mobile phone, is requested to track the location of multiple target devices, the UE 702 run into resource constraint issues such as large power specification and/or latency in getting multiple ranging measurements. In such cases, the LRM 1102 may be configured with the capability to enable a feature called ranging by proxy (RBP).

RBP may refer to a process where the UE 702 may request another device to perform the tracking/locationing/ranging for the UE (e.g., with other target devices). For example, this may occur when the UE 702 does not want to consume too much power and/or it does not desire to spend more time in finding/tracking other devices. Thus, instead of performing the tracking/locationing/ranging on its own, the UE 702 may assign another device/UE as a proxy (which may be referred to as a “proxy device” for illustration purposes) and request this proxy device to performing the tracking/locationing/ranging with other devices (e.g., peer/target devices), and send back the tracking/locationing/ranging measurements to the UE 702. For example, as shown at 1210, the UE 702 (or the LRM 1102) may request a proxy device 1202 (e.g., a trusted device with power plugged in such as an access point (AP), a home pod, etc.) to track locations of other peer devices and ask the proxy device 1202 to send back the location information associated with the peer devices.

As shown at 1212, the proxy device 1202 (e.g., with power plugged in) may use ranging, AoA, and/or multi-lateration to estimate the approximate/relative/absolute location(s) (collectively as “location information”) of the other peer devices (e.g., device 1 to N) and also the UE 702. After the proxy device 1202 obtains the location information of the N peer devices and the UE 702, the proxy device 1202 may share their locations to the UE 702 (e.g., relative locations with respect to the UE 702). Such configuration may greatly reduce power consumption load on a UE-side to range with multiple devices and offload it to proxy device(s) which have power plugged in. This may also reduce the latency constraints as the proxy device(s) may keep track of the location of the multiple devices. Similarly, continuous location discovery for a peer device may also be offloaded to the proxy device(s) and/or power plugged-in devices.

Referring back to FIG. 7, the unified RAT discovery (URD) module/protocol 708 may enable the UE 702 to discover one or more ranging technologies/RATs (for locationing/ranging) available at one or more peer/target devices, and enable the UE 702 to utilize at least one of ranging technologies/RATs at these peer/target devices (e.g., for locationing/ranging).

In some scenarios, applications/software that are configured to use locationing-capable RAT(s) may be specified to be aware of which ranging technology/RAT to use. However, each type of ranging technology/RAT (e.g., Wi-Fi, UWB, Bluetooth, etc.) may use a completely different API. Also, if a given ranging technology (UWB for example) is available in a just small percentage of devices compare to other ranging technologies (Wi-Fi and Bluetooth for example), individual application/software may be less likely to provide/add support for this given ranging technology because the effort of supporting a new API for this given ranging technology may not be justified/cost efficient.

In other scenarios, even if an application/software plans to support multiple ranging technologies/RATs, it may be specified to add custom logic to identify when multiple radio links (e.g., UWB and Wi-Fi) correspond to the same peer device, as these radio links may use different medium access control (MAC) address at the peer device. There may also not be a standard mechanism for two applications running on two separated devices to communicate to each other that they support multiple ranging technologies/RATs. As such, a universal mechanism may be specified by devices/UEs that enables any application/software to automatically leverage all the ranging technologies/RATs available on a given device/UE (without the application/software specifying modification), and also enables a way for a device/UE to discover that multiple ranging technology/RAT links correspond to the same peer device/UE.

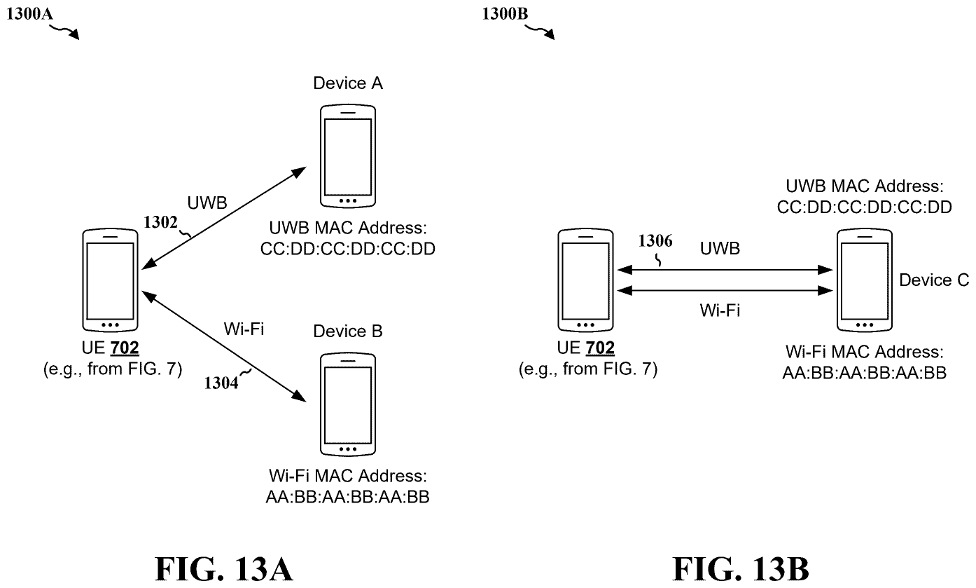

FIG. 13A is a diagram 1300A illustrating an example of two MAC addresses corresponding to two different peer devices in accordance with various aspects of the present disclosure. As shown at 1302, the UE 702 may connect to a first device (Device A) via UWB, where the UWB of the first device may have a specified UWB MAC address (e.g., “CC:DD:CC:DD:CC:DD” as an illustration). As shown at 1304, the UE 702 may also (concurrently/simultaneously) connect to a second device (Device B) via Wi-Fi, where the Wi-Fi of the second device may have a specified Wi-Fi MAC address (e.g., “AA:BB:AA:BB:AA:BB” as an illustration). In some scenarios, the UE 702 may be configured to assume that it is communicating with different devices based on different MAC addresses.

FIG. 13B is a diagram 1300B illustrating an example of two MAC addresses corresponding to the same peer device in accordance with various aspects of the present disclosure. However, in some scenarios, a UE may be communicated with one peer device using multiple ranging technologies/RATs. For example, as shown at 1306, the UE 702 may be communicating with a peer device (Device C) using both UWB and Wi-Fi, where the UWB and Wi-Fi of the peer device have different MAC address (e.g., UWB with MAC address “CC:DD:CC:DD:CC:DD” and Wi-Fi with MAC address “AA:BB:AA:BB:AA:BB” as an illustration). In such a scenario, the UE 702 may not be aware that it is communicating with the same peer device, and may assume that it is communicating with two different devices as described in connection with FIG. 13A.

In one aspect, the URD module/protocol 708 described herein may provide a standard mechanism for the UE 702 to discover that multiple ranging technology/RAT links correspond to the same peer device (e.g., Device C). For example, based on communication protocol(s) provided by the URD module/protocol 708, the UE 702 and one or more peer devices may exchange their MAC addresses for different ranging technologies/RATs with each other (e.g., such as ranging technologies that are to be used for communication between the UE 702 and the peer device(s)). As such, the UE 702 may become aware that it is communicating with the same peer device when multiple ranging technologies/RATs are used for the communication between them.

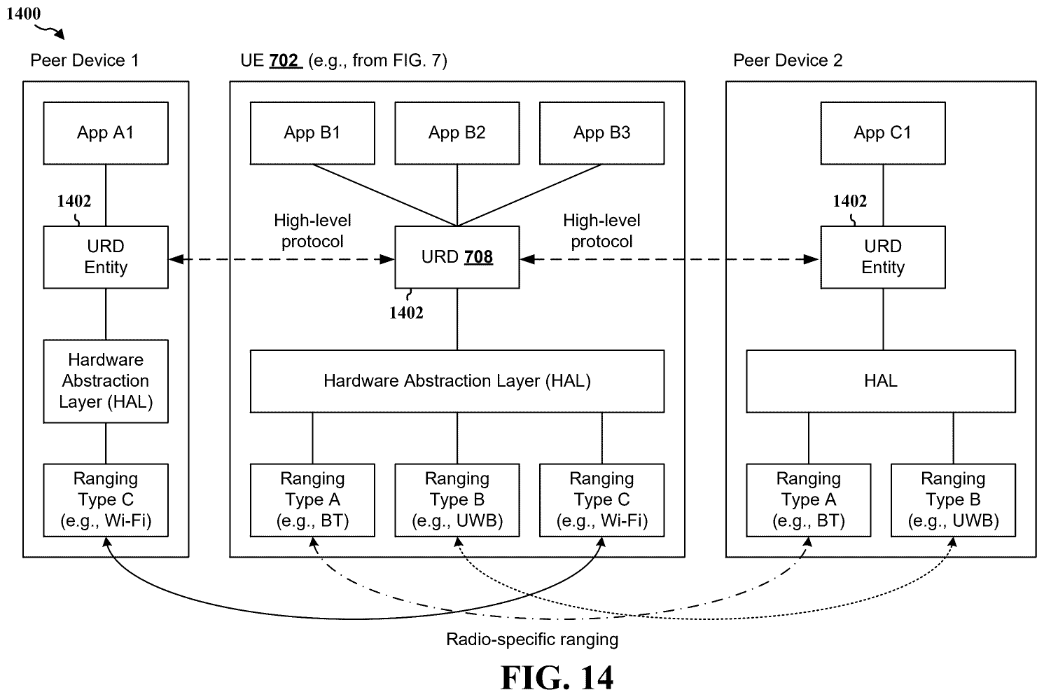

FIG. 14 is a diagram 1400 illustrating an example of multiple devices discovering ranging technologies of other devices based on URD in accordance with various aspects of the present disclosure. As shown at 1402, URD entities of different devices (e.g., the UE 702, a first peer device (Peer Device 1), and a second peer device (Peer Device 2) may be configured to sit on top of all supported ranging technologies/RATs, and may have the capability to access any of them to exchange messages with other entities. For example, the UE 702 may provide information related to its ranging technologies/RATs available for locationing/ranging (e.g., Bluetooth (BT), UWB, and Wi-Fi) to the first peer device and/or the second peer device via the URD module/protocol 708.

In some implementations, URD entities may send a given message over a single ranging technology/RAT, or replicate it across multiple ranging technologies/RATs for reliability. For example, the UE 702 may send a message to the second peer device using just BT, or using both BT and UWB. In some examples, messages transmitted between URD entities (which may be referred to as “URD message(s)” hereafter) may include sequence numbers to ensure receivers are able to drop duplicates.

In some examples, for the URD entities, each device may be configured to perform capability exchange (such as a broadcast of its capabilities) for the other device(s) to understand each device's specifications and capabilities that they support, such as band of operation, maximum bandwidth support and other valid/useful specifications. Below is an exemplary (high-level) description of URD messages that may be exchanged between URD entities on different devices (e.g., between UE 702 and the first peer device/second peer device):
Announce: My URD device_id is “xxxxx,” and I have UWB radio with MAC address xxx, Wi-Fi radio with MAC address yyy, and BT radio with MAC address zzz.
Announce: My radio “i” and my radio “j” cannot be used simultaneously.
Announce: My battery level is X %.
Announce: My selected radio for ranging is X.
Announce: I have an IMU and can keep track of (a) whether I am static or moving, (b) detailed IMU readings, (c) my relative displacement vs. some initial reference frame.
Request: start/stop tracking displacement.
Announce: my relative displacement at time t is (x, y, z) and my orientation is (a, b, c, d).
Announce: my IMU reading at time t is (ax, ay, az).

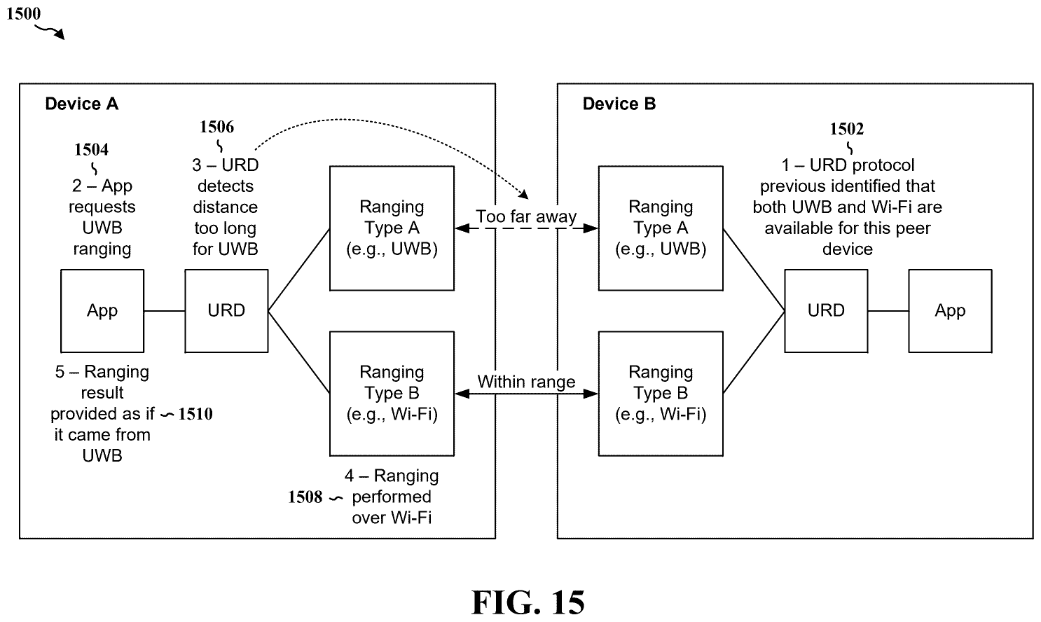

FIG. 15 is a diagram 1500 illustrating an example scenario of two devices communicating with each other based on two different ranging technologies in accordance with various aspects of the present disclosure. In some scenarios, one possible side effect of having radio agnostic peer device locationing capabilities is that even if one application requests ranging using a first type of ranging technology (e.g., UWB for example), the underlying system may use a different ranging technology (e.g., Wi-Fi for example) if there are technical benefits to do so. For example, as shown at 1502, a first device (Device A), based on using the URD protocol, may identify that a second device (Device B) is capable of using UWB and Wi-Fi for ranging. As shown at 1504, a default application (or a default OS) of the first device may use an API that supports just UWB (which may be referred to as “UWB-only API”) to request ranging against a peer device. However, as shown at 1506, the second device may be outside the range of UWB, but within range of Wi-Fi. Thus, as shown at 1508, the default application/OS may then decide to perform ranging using Wi-Fi “under the hood,” and report the result/measurement to the application/OS using the UWB-only API as shown at 1510.

Aspects presented herein may improve the overall performance of locationing and tracking for wireless devices that are capable of performing locationing and tracking with at least one ranging technology/RAT. Aspects presented herein may enable a wireless device to intelligently select one or more ranging technologies/RATs that are most suitable for locationing and tracking based the condition(s) and surrounding(s) of the wireless device. Aspects presented herein may also enable a wireless device to combine locationing and tracking measurements from one or more ranging technologies/RATs, such that multiple ranging technologies/RATs may be used concurrently/simultaneously to achieve a more accurate locationing and tracking compared to using just one ranging technology/RAT.

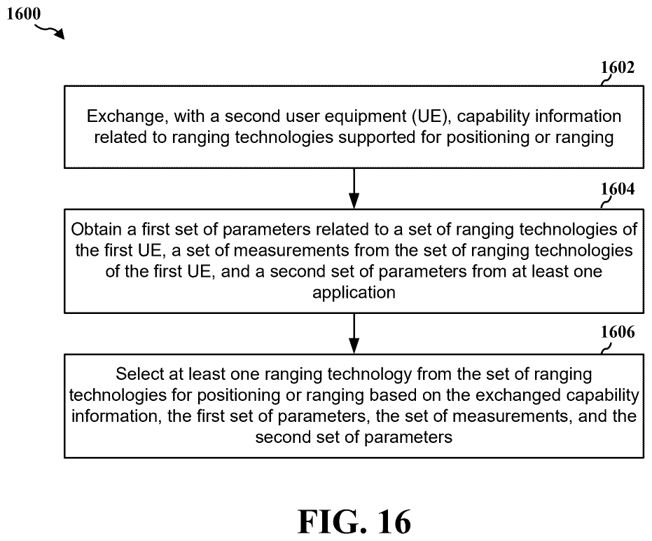

FIG. 16 is a flowchart 1600 of wireless communication at a user equipment (UE). The method may be performed by a first UE (e.g., the UE 104, 404, 702; the first device 502; the finder device 602; the apparatus 1704). The method may enable the first UE to select one or more ranging technologies that are most suitable for locationing and tracking based the condition(s) and/or surrounding(s) of the first UE.

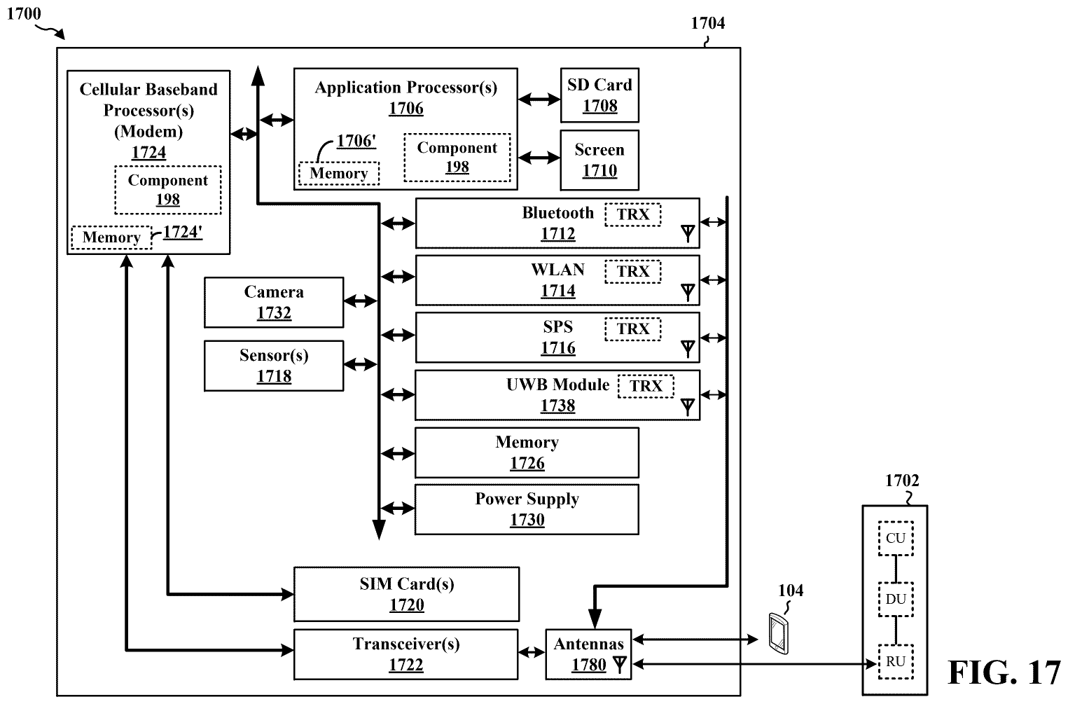

At 1602, the first UE may exchange, with a second UE, capability information related to ranging technologies supported for positioning or ranging, such as described in connection with FIGS. 7, 8, 11, and 14. For example, as discussed in connection with 1402 of FIG. 14, URD entities of different devices (e.g., the UE 702, a first peer device (Peer Device 1), and a second peer device (Peer Device 2) may be configured to sit on top of all supported ranging technology technologies, and may have the capability to access any of them to exchange messages with other entities. For example, the UE 702 may provide information related to its ranging technologies available for locationing/ranging (e.g., Bluetooth (BT), UWB, and Wi-Fi) to the first peer device and/or the second peer device via the URD module/protocol 708. The exchange of the capability information may be performed by, e.g., the ranging process component 198, the one or more sensors 1718, the UWB module 1738, the Bluetooth module 1712, the WLAN module 1714, the transceiver(s) 1722, the cellular baseband processor(s) 1724, and/or the application processor(s) 1706 of the apparatus 1704 in FIG. 17.

At 1604, the first UE may obtain a first set of parameters related to a set of ranging technologies of the first UE, a set of measurements from the set of ranging technologies of the first UE, and a second set of parameters from at least one application, such as described in connection with FIGS. 7, 8, 11, and 14. For example, as discussed in connection with 802 of FIG. 8, the OLE 706 may receive various parameters/information from multiple entities/modules of the UE 702, where these parameters/information may include: (1) metrics/parameters from unified radio agnostic API 704, (2) data from IMU sensors and camera, etc., (3) parameters from an application/software (e.g., power consumption specification, accuracy specification, etc.), (4) parameters from the UE 702 (e.g., battery level or a set of status of the UE), and/or (5) non-P2P/additional information from a cloud server, etc. The obtainment of the first set of parameters, the set of measurements, and the second set of parameters may be performed by, e.g., the ranging process component 198, the one or more sensors 1718, the UWB module 1738, the Bluetooth module 1712, the WLAN module 1714, the transceiver(s) 1722, the cellular baseband processor(s) 1724, and/or the application processor(s) 1706 of the apparatus 1704 in FIG. 17.

At 1606, the first UE may select at least one ranging technology from the set of ranging technologies for positioning or ranging based on the exchanged capability information, the first set of parameters, the set of measurements, and the second set of parameters, such as described in connection with FIGS. 7, 8, 11, and 14. For example, as discussed in connection with 804 of FIG. 8, based on at least some of the received parameters/information (e.g., from multiple entities/modules of the UE 702), the OLE 706 may be configured to select at least one ranging technology (from multiple ranging technologies) for performing the locationing and ranging. The selection of the at least one ranging technology may be performed by, e.g., the ranging process component 198, the one or more sensors 1718, the UWB module 1738, the Bluetooth module 1712, the WLAN module 1714, the transceiver(s) 1722, the cellular baseband processor(s) 1724, and/or the application processor(s) 1706 of the apparatus 1704 in FIG. 17.

In one example, the first UE may perform positioning or ranging with the second UE based on the selected at least one ranging technology.

In another example, to obtain the first set of parameters related to the set of ranging technologies of the first UE and the set of measurements from the set of ranging technologies of the first UE, the first UE may be configured to obtain the first set of parameters related to the set of ranging technologies of the first UE and the set of measurements from the set of ranging technologies of the first UE via a unified radio agnostic API or an API dedicated to receive location measurements from the set of ranging technologies.

In another example, the first set of parameters related to the set of ranging technologies of the first UE includes one or more of: channel center frequencies associated with the set of ranging technologies, channel conditions associated with the set of ranging technologies, packet bandwidths associated with the set of ranging technologies, estimated location parameters associated with the set of ranging technologies, error estimates associated with the set of ranging technologies, or ranging technology availability for the set of ranging technologies.

In another example, the at least one ranging technology is a plurality of ranging technologies, and the set of measurements include multiple measurements from one or more positions or orientations of the plurality of ranging technologies, the first UE may combine the multiple measurements into one measurement or a reduced number of measurements. In some implementations, the selection of the at least one ranging technology from the set of ranging technologies is further based on the one measurement or the reduced number of measurements. In some implementations, the first UE may estimate at least one of a position, a distance, or a direction of the second UE based on the one measurement or the reduced number of measurements, or output an indication of the one measurement or the reduced number of measurements.

In another example, to select the at least one ranging technology from the set of ranging technologies for positioning or ranging based on the exchanged capability information, the first set of parameters, the set of measurements, and the second set of parameters, the first UE may be configured to determine, based on the first set of parameters, the set of measurements, and the second set of parameters, at least one of: a rough estimated distance between the first UE and the second UE, an orientation of one or more antennas of the first UE or the second UE associated with the at least one ranging technology, a power consumption specified by the first UE or the second UE, or an accuracy specified by the first UE or the second UE; and select the at least one ranging technology for positioning or ranging with the second UE based on at least one of the rough estimated distance, the orientation, the power consumption, or the accuracy.

In another example, the second set of parameters includes one or more of: a power consumption received from the at least one application, or an accuracy received from the at least one application.

In another example, the first UE may obtain at least one of: sensor data from at least one sensor, a third set of parameters related to the first UE, or non-P2P or additional information from a server, where the selection of the at least one ranging technology from the set of ranging technologies is further based on at least one of the sensor data, the third set of parameters, or the non-P2P or additional information. In some implementations, the non-P2P or additional information includes a recommendation of one or more ranging technologies in the set of ranging technologies to be used for positioning or ranging, where the recommendation is based on at least one of: a coarse distance between the first UE and the second UE, a line-of-sight (LoS) or non-line-of-sight (NLoS) channel condition between the first UE and the second UE, common ranging technologies and channels supported by the first UE and the second UE, a power level of the first UE and the second UE, and/or any valid parameters/metrics that can be used by an OLE/the first UE. In some implementations, the third set of parameters includes at least a battery level of the first UE or a set of status of the first UE. In some implementation, to obtain the sensor data from the at least one sensor, the first UE may be configured to obtain the sensor data from at least one of a camera or a lidar. In some implementations, the non-P2P or additional information includes at least one of: a set of GNSS measurements related to a set of UEs, a set of latitude and longitude points of the set of UEs, a set of ranging technology capabilities related to the set of UEs, a set of operating frequency channels supported by the set of the set of UEs, a set of features supported by the set of the set of UEs, a set of sensor or camera measurements performed by set of the set of UEs.

In another example, the first UE may receive, from the at least one application or the second UE, a plurality of requests associated with positioning or ranging, and prioritize the plurality of requests via a location resource manager (LRM) based on the first set of parameters, the set of measurements, and the second set of parameters.

In another example, the first UE may transmit, to at least one third UE, a request to perform positioning or ranging against the second UE, and receive, from the at least one third UE based on the request, a set of positioning or ranging measurements related to the second UE.

In another example, to exchange, with the second UE, the capability information related to the ranging technologies supported for positioning or ranging, the first UE may be configured to transmit, to the second UE, first information including a first set of ranging technologies supported by the first UE for positioning or ranging, and receive, from the second UE, second information including a second set of ranging technologies supported by the second UE for positioning or ranging. In some implementations, the first information and the second information further include identifications or media access control (MAC) addresses associated with the first set of ranging technologies or the second set of ranging technologies. In some implementations, the selection of the at least one ranging technology from the set of ranging technologies is further based on the first information and the second information.

In another example, the first UE may output an indication of the selected at least one ranging technology. In some implementations, to output the indication of the selected at least one ranging technology, the first UE may be configured to store the indication of the selected at least one ranging technology, or transmit the indication of the selected at least one ranging technology.

In another example, the first UE may determine, based on the first set of parameters related to the set of ranging technologies of the first UE, at least one of a duration for which a current set of location parameters is valid or a frequency for performing positioning or ranging.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include at least one cellular baseband processor 1724 (also referred to as a modem) coupled to one or more transceivers 1722 (e.g., cellular RF transceiver). The cellular baseband processor(s) 1724 may include at least one on-chip memory 1724′. In some aspects, the apparatus 1704 may further include one or more subscriber identity modules (SIM) cards 1720 and at least one application processor 1706 coupled to a secure digital (SD) card 1708 and a screen 1710. The application processor(s) 1706 may include on-chip memory 1706′. In some aspects, the apparatus 1704 may further include a Bluetooth module 1712, a WLAN module 1714, an ultrawide band (UWB) module 1738 (e.g., a UWB transceiver), an SPS module 1716 (e.g., GNSS module), one or more sensors 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the UWB module 1738, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor(s) 1724 communicates through the transceiver(s) 1722 via one or more antennas 1780 with the UE 104 and/or with an RU associated with a network entity 1702. The cellular baseband processor(s) 1724 and the application processor(s) 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor(s) 1724 and the application processor(s) 1706 are each responsible for general processing, including the execution of software stored on the computer-readable medium/memory. The software, when executed by the cellular baseband processor(s) 1724/application processor(s) 1706, causes the cellular baseband processor(s) 1724/application processor(s) 1706 to perform the various functions described supra. The cellular baseband processor(s) 1724 and the application processor(s) 1706 are configured to perform the various functions described supra based at least in part of the information stored in the memory. That is, the cellular baseband processor(s) 1724 and the application processor(s) 1706 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1724/application processor(s) 1706 when executing software. The cellular baseband processor(s) 1724/application processor(s) 1706 may be a component of the UE 350 and may include the at least one memory 360 and/or at least one of the TX processor 368, the RX processor 356, and the controller/processor 359. In one configuration, the apparatus 1704 may be at least one processor chip (modem and/or application) and include just the cellular baseband processor(s) 1724 and/or the application processor(s) 1706, and in another configuration, the apparatus 1704 may be the entire UE (e.g., see UE 350 of FIG. 3) and include the additional modules of the apparatus 1704.

As discussed supra, the ranging process component 198 may be configured to exchange, with a second UE, capability information related to ranging technologies supported for positioning or ranging. The ranging process component 198 may also be configured to obtain a first set of parameters related to a set of ranging technologies of the first UE, a set of measurements from the set of ranging technologies of the first UE, and a second set of parameters from at least one application. The ranging process component 198 may also be configured to select at least one ranging technology from the set of ranging technologies for positioning or ranging based on the exchanged capability information, the first set of parameters, the set of measurements, and the second set of parameters. The ranging process component 198 may be within the cellular baseband processor(s) 1724, the application processor(s) 1706, or both the cellular baseband processor(s) 1724 and the application processor(s) 1706. The ranging process component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1704 may include a variety of components configured for various functions. In one configuration, the apparatus 1704, and in particular the cellular baseband processor(s) 1724 and/or the application processor(s) 1706, may include means for exchanging, with a second UE, capability information related to ranging technologies supported for positioning or ranging. The apparatus 1704 may further include means for obtaining a first set of parameters related to a set of ranging technologies of the first UE, a set of measurements from the set of ranging technologies of the first UE, and a second set of parameters from at least one application. The apparatus 1704 may further include means for selecting at least one ranging technology from the set of ranging technologies for positioning or ranging based on the exchanged capability information, the first set of parameters, the set of measurements, and the second set of parameters.

In one configuration, the apparatus 1704 may further include means for performing positioning or ranging with the second UE based on the selected at least one ranging technology.

In another configuration, the means for obtaining the first set of parameters related to the set of ranging technologies of the first UE and the set of measurements from the set of ranging technologies of the first UE may include configuring the apparatus 1704 to obtain the first set of parameters related to the set of ranging technologies of the first UE and the set of measurements from the set of ranging technologies of the first UE via a unified radio agnostic API or an API dedicated to receive location measurements from the set of ranging technologies.

In another configuration, the first set of parameters related to the set of ranging technologies of the first UE includes one or more of: channel center frequencies associated with the set of ranging technologies, channel conditions associated with the set of ranging technologies, packet bandwidths associated with the set of ranging technologies, estimated location parameters associated with the set of ranging technologies, error estimates associated with the set of ranging technologies, or ranging technology availability for the set of ranging technologies.

In another configuration, the at least one ranging technology is a plurality of ranging technologies, and the set of measurements include multiple measurements from one or more positions or orientations of the plurality of ranging technologies, the apparatus 1704 may further include means for combining the multiple measurements into one measurement or a reduced number of measurements. In some implementations, the selection of the at least one ranging technology from the set of ranging technologies is further based on the one measurement or the reduced number of measurements. In some implementations, the apparatus 1704 may further include means for estimating at least one of a position, a distance, or a direction of the second UE based on the one measurement or the reduced number of measurements, or means for outputting an indication of the one measurement or the reduced number of measurements.

In another configuration, the means for selecting the at least one ranging technology from the set of ranging technologies for positioning or ranging based on the exchanged capability information, the first set of parameters, the set of measurements, and the second set of parameters may include configuring the apparatus 1704 to determine, based on the first set of parameters, the set of measurements, and the second set of parameters, at least one of: a rough estimated distance between the first UE and the second UE, an orientation of one or more antennas of the first UE or the second UE associated with the at least one ranging technology, a power consumption specified by the first UE or the second UE, or an accuracy specified by the first UE or the second UE; and select the at least one ranging technology for positioning or ranging with the second UE based on at least one of the rough estimated distance, the orientation, the power consumption, or the accuracy.

In another configuration, the second set of parameters includes one or more of: a power consumption received from the at least one application, or an accuracy received from the at least one application.

In another configuration, the apparatus 1704 may further include means for obtaining at least one of: sensor data from at least one sensor, a third set of parameters related to the first UE, or non-P2P or additional information from a server, where the selection of the at least one ranging technology from the set of ranging technologies is further based on at least one of the sensor data, the third set of parameters, or the non-P2P or additional information. In some implementations, the non-P2P or additional information includes a recommendation of one or more ranging technologies in the set of ranging technologies to be used for positioning or ranging, where the recommendation is based on at least one of: a coarse distance between the first UE and the second UE, a LoS or NLoS channel condition between the first UE and the second UE, common ranging technologies and channels supported by the first UE and the second UE, or a power level of the first UE and the second UE. In some implementations, the third set of parameters includes at least a battery level of the first UE or a set of status of the first UE. In some implementation, the means for obtaining the sensor data from the at least one sensor may include configuring the apparatus 1704 to obtain the sensor data from at least one of a camera or a lidar. In some implementations, the non-P2P or additional information includes at least one of: a set of GNSS measurements related to a set of UEs, a set of latitude and longitude points of the set of UEs, a set of ranging technology capabilities related to the set of UEs, a set of operating frequency channels supported by the set of the set of UEs, a set of features supported by the set of the set of UEs, a set of sensor or camera measurements performed by set of the set of UEs.

In another configuration, the apparatus 1704 may further include means for receiving, from multiple applications or multiple UEs, a plurality of requests associated with positioning or ranging, and means for prioritizing the plurality of requests via an LRM based on the first set of parameters, the set of measurements, and the second set of parameters.

In another configuration, the apparatus 1704 may further include means for transmitting, to at least one third UE, a request to perform positioning or ranging against the second UE, and means for receiving, from the at least one third UE based on the request, a set of positioning or ranging measurements related to the second UE.

In another configuration, the means for exchanging, with the second UE, the capability information related to the ranging technologies supported for positioning or ranging may include configuring the apparatus 1704 to transmit, to the second UE, first information including a first set of ranging technologies supported by the first UE for positioning or ranging, and receive, from the second UE, second information including a second set of ranging technologies supported by the second UE for positioning or ranging. In some implementations, the first information and the second information further include identifications or MAC addresses associated with the first set of ranging technologies or the second set of ranging technologies. In some implementations, the selection of the at least one ranging technology from the set of ranging technologies is further based on the first information and the second information.

In another configuration, the apparatus 1704 may further include means for outputting an indication of the selected at least one ranging technology. In some implementations, the means for outputting the indication of the selected at least one ranging technology may include configuring the apparatus 1704 to store the indication of the selected at least one ranging technology, or transmit the indication of the selected at least one ranging technology.

In another configuration, the apparatus 1704 may further include means for determining, based on the first set of parameters related to the set of ranging technologies of the first UE, at least one of a duration for which a current set of location parameters is valid or a frequency for performing positioning or ranging.

The means may be the ranging process component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first user equipment (UE), comprising: exchanging, with a second UE, capability information related to ranging technologies supported for positioning or ranging; obtaining a first set of parameters related to a set of ranging technologies of the first UE, a set of measurements from the set of ranging technologies of the first UE, and a second set of parameters from at least one application; and selecting at least one ranging technology from the set of ranging technologies for positioning or ranging based on the exchanged capability information, the first set of parameters, the set of measurements, and the second set of parameters.

Aspect 2 is the method of aspect 1, further comprising: performing positioning or ranging with the second UE based on the selected at least one ranging technology.

Aspect 3 is the method of aspect 1 or aspect 2, wherein the first set of parameters related to the set of ranging technologies of the first UE includes one or more of: channel center frequencies associated with the set of ranging technologies, channel conditions associated with the set of ranging technologies, packet bandwidths associated with the set of ranging technologies, estimated location parameters associated with the set of ranging technologies, error estimates associated with the set of ranging technologies, or ranging technology availability for the set of ranging technologies.

Aspect 4 is the method of any of aspects 1 to 3, wherein the at least one ranging technology is a plurality of ranging technologies, wherein the set of measurements include multiple measurements from one or more positions or orientations of the plurality of ranging technologies, the method further comprises: combining the multiple measurements into one measurement or a reduced number of measurements.

Aspect 5 is the method of any of aspects 1 to 4, wherein the selection of the at least one ranging technology from the set of ranging technologies is further based on the one measurement or the reduced number of measurements.

Aspect 6 is the method of any of aspects 1 to 5, further comprising: estimating at least one of a position, a distance, or a direction of the second UE based on the one measurement or the reduced number of measurements, or outputting an indication of the one measurement or the reduced number of measurements.

Aspect 7 is the method of any of aspects 1 to 6, wherein selecting the at least one ranging technology from the set of ranging technologies for positioning or ranging based on the exchanged capability information, the first set of parameters, the set of measurements, and the second set of parameters comprises: determining, based on the first set of parameters, the set of measurements, and the second set of parameters, at least one of: a rough estimated distance between the first UE and the second UE, an orientation of one or more antennas of the first UE or the second UE associated with the at least one ranging technology, a power consumption specified by the first UE or the second UE, or an accuracy specified by the first UE or the second UE; and selecting the at least one ranging technology for positioning or ranging with the second UE based on at least one of the rough estimated distance, the orientation, the power consumption, or the accuracy.

Aspect 8 is the method of any of aspects 1 to 7, wherein the second set of parameters includes one or more of: a power consumption received from the at least one application, or an accuracy received from the at least one application.

Aspect 9 is the method of any of aspects 1 to 8, further comprising: obtaining at least one of: sensor data from at least one sensor, a third set of parameters related to the first UE, or non-peer-to-peer (non-P2P) or additional information from a server, wherein the selection of the at least one ranging technology from the set of ranging technologies is further based on at least one of the sensor data, the third set of parameters, or the non-P2P or additional information.

Aspect 10 is the method of any of aspects 1 to 9, wherein the non-P2P or additional information includes a recommendation of one or more ranging technologies in the set of ranging technologies to be used for positioning or ranging, wherein the recommendation is based on at least one of: a coarse distance between the first UE and the second UE, a line-of-sight (LoS) or non-line-of-sight (NLoS) channel condition between the first UE and the second UE, common ranging technologies and channels supported by the first UE and the second UE, or a power level of the first UE and the second UE.

Aspect 11 is the method of any of aspects 1 to 10, wherein the third set of parameters includes at least a battery level of the first UE or a set of status of the first UE.

Aspect 12 is the method of any of aspects 1 to 11, wherein obtaining the sensor data from the at least one sensor comprises: obtaining the sensor data from at least one of a camera or a lidar.

Aspect 13 is the method of any of aspects 1 to 12, wherein obtaining the first set of parameters related to the set of ranging technologies of the first UE and the set of measurements from the set of ranging technologies of the first UE comprises: obtaining the first set of parameters related to the set of ranging technologies of the first UE and the set of measurements from the set of ranging technologies of the first UE via a unified radio agnostic application programming interface (API) or an API dedicated to receive location measurements from the set of ranging technologies.

Aspect 14 is the method of any of aspects 1 to 13, further comprising: receiving, from multiple applications or multiple UEs, a plurality of requests associated with positioning or ranging; and prioritizing the plurality of requests via a location resource manager (LRM) based on the first set of parameters, the set of measurements, and the second set of parameters.

Aspect 15 is the method of any of aspects 1 to 14, further comprising: transmitting, to at least one third UE, a request to perform positioning or ranging against the second UE; and receiving, from the at least one third UE based on the request, a set of positioning or ranging measurements related to the second UE.

Aspect 16 is the method of any of aspects 1 to 15, wherein exchanging, with the second UE, the capability information related to the ranging technologies supported for positioning or ranging comprises: transmitting, to the second UE, first information including a first set of ranging technologies supported by the first UE for positioning or ranging; and receiving, from the second UE, second information including a second set of ranging technologies supported by the second UE for positioning or ranging.

Aspect 17 is the method of any of aspects 1 to 16, wherein the first information and the second information further include identifications or media access control (MAC) addresses associated with the first set of ranging technologies or the second set of ranging technologies.

Aspect 18 is the method of any of aspects 1 to 17, wherein the selection of the at least one ranging technology from the set of ranging technologies is further based on the first information and the second information.

Aspect 19 is the method of any of aspects 1 to 18, further comprising: outputting an indication of the selected at least one ranging technology.

Aspect 20 is the method of any of aspects 1 to 19, wherein outputting the indication of the selected at least one ranging technology comprises: storing the indication of the selected at least one ranging technology, or transmitting the indication of the selected at least one ranging technology.

Aspect 21 is the method of any of aspects 1 to 20, further comprising: determine, based on the first set of parameters related to the set of ranging technologies of the first UE, at least one of a duration for which a current set of location parameters is valid or a frequency for performing positioning or ranging.

Aspect 22 is an apparatus for wireless communication at a first user equipment (UE), including: at least one memory; and at least one processor coupled to the at least one memory and, based at least in part on stored information that is stored in the at least one memory, the at least one processor, individually or in any combination, is configured to implement any of aspects 1 to 21.

Aspect 23 is the apparatus of aspect 22, further including at least one transceiver coupled to the at least one processor.

Aspect 24 is an apparatus for wireless communication at a first user equipment (UE) including means for implementing any of aspects 1 to 21.

Aspect 25 is a computer-readable medium (e.g., a non-transitory computer-readable medium) storing computer executable code, where the code when executed by a processor causes the processor to implement any of aspects 1 to 21.

What is claimed is:

1. An apparatus for wireless communication at a first user equipment (UE), comprising:
at least one memory; and
at least one processor coupled to the at least one memory, the at least one processor, individually or in any combination, is configured to:
exchange, with a second UE, capability information related to ranging technologies supported for positioning or ranging;
obtain a first set of parameters related to a set of ranging technologies of the first UE, a set of measurements from the set of ranging technologies of the first UE, and a second set of parameters from at least one application; and
select at least one ranging technology from the set of ranging technologies for positioning or ranging based on the exchanged capability information, the first set of parameters, the set of measurements, and the second set of parameters.

2. The apparatus of claim 1, wherein to obtain the first set of parameters related to the set of ranging technologies of the first UE and the set of measurements from the set of ranging technologies of the first UE, the at least one processor, individually or in any combination, is configured to:
obtain the first set of parameters related to the set of ranging technologies of the first UE and the set of measurements from the set of ranging technologies of the first UE via a unified radio agnostic application programming interface (API) or an API dedicated to receive location measurements from the set of ranging technologies.

3. The apparatus of claim 1, wherein the at least one processor, individually or in any combination, is further configured to:
perform positioning or ranging with the second UE based on the selected at least one ranging technology.

4. The apparatus of claim 1, wherein the first set of parameters related to the set of ranging technologies of the first UE includes one or more of:
channel center frequencies associated with the set of ranging technologies,
channel conditions associated with the set of ranging technologies,
packet bandwidths associated with the set of ranging technologies,
estimated location parameters associated with the set of ranging technologies,
error estimates associated with the set of ranging technologies, or
ranging technology ranging technology availability for the set of ranging technologies.

5. The apparatus of claim 1, wherein the at least one ranging technology ranging technology is a plurality of ranging technologies, wherein the set of measurements include multiple measurements from one or more positions or orientations of the plurality of ranging technologies, the at least one processor, individually or in any combination, is further configured to:
combine the multiple measurements into one measurement or a reduced number of measurements.

6. The apparatus of claim 5, wherein the selection of the at least one ranging technology ranging technology from the set of ranging technologies is further based on the one measurement or the reduced number of measurements.

7. The apparatus of claim 5, wherein the at least one processor, individually or in any combination, is further configured to:
estimate at least one of a position, a distance, or a direction of the second UE based on the one measurement or the reduced number of measurements, or
output an indication of the one measurement or the reduced number of measurements.

8. The apparatus of claim 1, wherein to select the at least one ranging technology ranging technology from the set of ranging technologies for positioning or ranging based on the exchanged capability information, the first set of parameters, the set of measurements, and the second set of parameters, the at least one processor, individually or in any combination, is configured to:
determine, based on the first set of parameters, the set of measurements, and the second set of parameters, at least one of:
a rough estimated distance between the first UE and the second UE,
an orientation of one or more antennas of the first UE or the second UE associated with the at least one ranging technology,
a power consumption specified by the first UE or the second UE, or
an accuracy specified by the first UE or the second UE; and
select the at least one ranging technology for positioning or ranging with the second UE based on at least one of the rough estimated distance, the orientation, the power consumption, or the accuracy.

9. The apparatus of claim 1, wherein the second set of parameters includes one or more of:
a power consumption received from the at least one application, or
an accuracy received from the at least one application.

10. The apparatus of claim 1, wherein the at least one processor, individually or in any combination, is further configured to:
obtain at least one of:
sensor data from at least one sensor,
a third set of parameters related to the first UE, or
non-peer-to-peer (non-P2P) or additional information from a server,
wherein the selection of the at least one ranging technology ranging technology from the set of ranging technologies is further based on at least one of the sensor data, the third set of parameters, or the non-P2P or additional information.

11. The apparatus of claim 10, wherein the non-P2P or additional information includes a recommendation of one or more ranging technologies in the set of ranging technologies to be used for positioning or ranging, wherein the recommendation is based on at least one of:
a coarse distance between the first UE and the second UE,
a line-of-sight (LoS) or non-line-of-sight (NLoS) channel condition between the first UE and the second UE,
common ranging technologies and channels supported by the first UE and the second UE, or
a power level of the first UE and the second UE.

12. The apparatus of claim 10, wherein the third set of parameters includes at least a battery level of the first UE or a set of status of the first UE.

13. The apparatus of claim 10, wherein the non-P2P or additional information includes at least one of: a set of global navigation satellite system (GNSS) measurements related to a set of UEs, a set of latitude and longitude points of the set of UEs, a set of ranging technology ranging technology capabilities related to the set of UEs, a set of operating frequency channels supported by the set of the set of UEs, a set of features supported by the set of the set of UEs, a set of sensor or camera measurements performed by set of the set of UEs.

14. The apparatus of claim 1, wherein the at least one processor, individually or in any combination, is further configured to:
receive, from multiple applications or multiple UEs, a plurality of requests associated with positioning or ranging; and
prioritize the plurality of requests via a location resource manager (LRM) based on the first set of parameters, the set of measurements, and the second set of parameters.

15. The apparatus of claim 1, wherein the at least one processor, individually or in any combination, is further configured to:
transmit, to at least one third UE, a request to perform positioning or ranging against the second UE; and
receive, from the at least one third UE based on the request, a set of positioning or ranging measurements related to the second UE.

16. The apparatus of claim 1, wherein to exchanging, with the second UE, the capability information related to the ranging technologies supported for positioning or ranging, the at least one processor, individually or in any combination, is configured to:
transmit, to the second UE, first information including a first set of ranging technologies supported by the first UE for positioning or ranging; and
receive, from the second UE, second information including a second set of ranging technologies supported by the second UE for positioning or ranging.

17. The apparatus of claim 1, wherein the at least one processor, individually or in any combination, is further configured to:
determine, based on the first set of parameters related to the set of ranging technologies of the first UE, at least one of a duration for which a current set of location parameters is valid or a frequency for performing positioning or ranging.

18. The apparatus of claim 1, further comprising at least one of a transceiver or an antenna coupled to the at least one processor, wherein the at least one processor, individually or in any combination, is further configured to:
output an indication of the selected at least one ranging technology, wherein to output the indication of the selected at least one ranging technology, the at least one processor, individually or in any combination, is configured to store the indication of the selected at least one ranging technology, or transmit, via at least one of the transceiver or the antenna, the indication of the selected at least one ranging technology.

19. A method of positioning at a first user equipment (UE), comprising:
exchanging, with a second UE, capability information related to ranging technologies supported for positioning or ranging;
obtaining a first set of parameters related to a set of ranging technologies of the first UE, a set of measurements from the set of ranging technologies of the first UE, and a second set of parameters from at least one application; and
selecting at least one ranging technology ranging technology from the set of ranging technologies for positioning or ranging based on the exchanged capability information, the first set of parameters, the set of measurements, and the second set of parameters.

20. A computer-readable medium storing computer executable code at a first user equipment (UE) the code when executed by at least one processor causes the at least one processor to:
exchange, with a second UE, capability information related to ranging technologies supported for positioning or ranging;
obtain a first set of parameters related to a set of ranging technologies of the first UE, a set of measurements from the set of ranging technologies of the first UE, and a second set of parameters from at least one application; and
select at least one ranging technology ranging technology from the set of ranging technologies for positioning or ranging based on the exchanged capability information, the first set of parameters, the set of measurements, and the second set of parameters.
